(19) United States
(12) Patent Application Publication
(10) Pub. No.: US 2008/0113165 A1
(43) Pub. Date: May 15, 2008

(54) Antireflection Film, Polarizing Plate and Image Display Utilizing the Same

(75) Inventor: Hidetoshi Watanabe, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/658,097

(22) PCT Filed: Jul. 20, 2005
(86) PCT No.: PCT/JP05/13684

§ 371 Date: Jan. 22, 2007

(30) Foreign Application Priority Data
Jul. 20, 2004 (JP) 2004-211763
Sep. 3, 2004 (JP) 2004-256647

(51) Int. Cl. B32B 7/02

(52) U.S. Cl. 428/212

(57) ABSTRACT

An antireflection film with a sufficient antireflection property in addition to the scratch resistance is provided. The antireflection film includes a transparent substrate; a hard coat layer; and a low refractive index layer having a refractive index lower than that of the transparent substrate in this order, and satisfies the specific equation of the reflectance or the chromaticity difference.

### TECHNICAL FIELD

The present invention relates to an antireflection film, more particularly to an antireflection film excellent in a scratch resistance, and further to a polarizing plate and image display utilizing such antireflection film.

### BACKGROUND ART

An antireflection film is generally employed in a display such as a cathode ray tube display (CRT), a plasma display panel (PDP), an electroluminescent display (ELD) or a liquid crystal display (LCD), on an outermost surface of such display in order to reduce a reflectance by the principle of an optical interference, thereby preventing a reduction in a display contrast by a reflection of an external light or a reflection of an external image. Therefore the antireflection film is required to have a high scratch resistance.

In general, an antireflection film can be prepared by forming, on a substrate, a low refractive index layer having an appropriate thickness and a refractive index lower than that of the substrate. The low refractive index layer is required to have a refractive index as low as possible in order to realize a low reflectance.

For reducing the refractive index of a material, there are known methods of (1) introducing a fluorine atom, and (2) reducing a density (introducing cavities), but these methods tend to deteriorate the film strength and the scratch resistance, and it has been difficult to achieve a low refractive index and a high scratch resistance at the same time.

As a material for providing a film of a lower refractive index, a fluorine-containing polymer is often employed, and for curing the fluorine-containing polymer of such low refractive index, it is often executed to cure various polymers containing for example a hydroxyl group with a curing agent, as described in JP-A-8-92323 and JP-A-2000-17028. However the curing agent and the fluorine-containing polymer are often insufficient in the mutual solubility, and an improvement has been desired in the transparency and the film hardness.

On this point, JP-10-25388 discloses a technology of partially condensing a melamine curing agent and a hydroxyl-containing polymer of a lower refractive index by a preliminary heating, and such technology is effective to a certain extent in improving the transparency of the film but is still insufficient in the film hardness.

Also for testing the scratch resistance, there is known a testing method with steel wool as described in JIS-K-5600-5-4 (scratch hardness: pencil method) and JP-A-2001-74907, but such method cannot be considered practical for testing the scratch resistance of the surface of a display.

JP-A-11-31337 describes a method of testing the scratch resistance with powder dust and polyester fibers, and such method, though employing materials close to those encountered in actual use, relies on a special testing method and on a visual subjective sensual evaluation method for evaluating the test results, and thus cannot be considered a practical testing method.

Also JP-A-5-36350 and JP-A-2002-196128 describe an eraser rubbing test for evaluating the scratch resistance, which does not specify detailed test conditions and relies on a visual subjective sensual evaluation method for evaluating the test results, and thus cannot be considered a practical testing method.

In this manner there is desired an antireflection film having the scratch resistance and the antireflection property, though an improvement in the scratch resistance for example of the antireflection film is restricted by the absence of a practical test method appropriately reflecting the scratch resistance of the display surface.

### DISCLOSURE OF THE INVENTION

An object of an illustrative, non-limiting embodiment of the present invention is to provide an antireflection film with an improved scratch resistance. Another object is to provide an antireflection film with a sufficient antireflection property in addition to the scratch resistance. Still another object is to provide a polarizing plate or an image display utilizing such antireflection film.

The present inventors, as a result of intensive investigations on the relationship between the scratch resistance and the antireflective property of a film, have found a method of quantitatively evaluating the scratch resistance of an antireflection film by a measured change rate in the reflection determined by introducing a novel eraser rubbing test, and have found that an antireflection film having a change rate in the reflectance, measured by such method, of 30% or less has an excellent scratch resistance.

Also the present inventors, as a result of intensive investigations on the relationship between the scratch resistance and the antireflective property of a film, have found a method of quantitatively evaluating the scratch resistance of an antireflection film by a measured change in the chromaticity of a reflected light determined by introducing a novel non-woven cloth rubbing test, and have found that an antireflection film having a change in the chromaticity of the reflected light, measured by such method, of 1 or less has an excellent scratch resistance.

Also the present inventors have found that a polymer itself of a film, having a (meth)acryloyl group, which is a self crosslinkable group, in a side chain is advantageous in realizing a satisfactory scratch resistance and a low refractive index at the same time, and that an acceleration of the curing reaction (crosslinking reaction) in an atmosphere with an oxygen concentration of 0.03% by volume or less is advantageous for a film hardness. It is further found that an evident effect can be obtained at the curing reaction (crosslinking reaction) by accelerating the photocuring reaction under heating so as to maintain a film surface at a temperature of 60° C. or higher.

The present invention can provide an antireflection film (first embodiment), a polarizing plate and an image display of configurations to be explained in the following and the aforementioned objects can be attained.

(1-1) An antireflection film including: a transparent substrate; a hard coat layer; and a low refractive index layer having a refractive index lower than that of the transparent substrate in this order, wherein the antireflection film has a change rate in reflectance of 30% or less, the change rate being calculated by equation (I):

$$reflectance change rate ( \% ) = \frac{reflectance B - reflectance A}{reflectance A} \times 100$$

wherein the reflectance A indicates a reflectance of the antireflection film before rubbing a surface of a side of the low refractive index layer with an eraser, and the reflectance B is a reflectance of the antireflection film after rubbing the surface of the side of the low refractive index layer with an eraser by 50 reciprocating cycles under a load of 9.8 N/cm².

(1-2) The antireflection film described in (1-1), wherein the low refractive index layer is formed from a coating liquid including a fluorine-containing polymer that the polymer is a copolymer containing: a polymerization unit derived from a fluorine-containing vinyl monomer; and a polymerization unit having a singly crosslinkable (meth)acryloyl group in a side chain thereof, the copolymer having a main chain of only carbon atoms.

(1-3) The antireflection film described in (1-2), wherein the copolymer is a copolymer represented by formula (1):

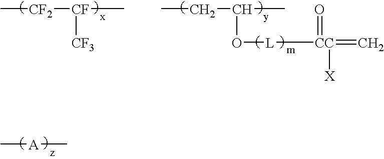

wherein L represents a divalent connecting group having 1 to 10 carbon atoms; m represents 0 or 1; X represents a hydrogen atom or a methyl group; A represents a polymerization unit derived from a vinyl monomer, which may be a single component or plural components; and x, y, z each represents a molar percentage of each constituent and satisfies conditions 30≦x≦60, 5≦y≦70 and 0≦z≦65.

(1-4) The antireflection film described in any one of (1-1) to (1-3), wherein the low refractive index layer is formed from a coating liquid containing the fluorine-containing polymer and inorganic fine particles.

(1-5) The antireflection film described in (1-4), wherein the inorganic fine particles are hollow silica fine particles having a refractive index of 1.17 to 1.40.

(1-6) The antireflection film described in any one of (1-1) to (1-5), wherein at least one of the hard coat layer and the low refractive index layer is formed from a coating liquid containing at least one of an organosilane compound, a hydrolysate thereof and a partial condensate thereof.

(1-7) The antireflection film described in any one of (1-1) to (1-6), wherein the low refractive index layer is crosslinked in an atmosphere with an oxygen concentration of 0.03% by volume or less.

(1-8) A polarizing plate including: a polarizer; and two protective films, at least one of the two protective films including an antireflection film described in any one of (1-1) to (1-7).

(1-9) The polarizing plate described in (1-8), wherein one of the at least two protective films includes the antireflection film, and the other of the at least two protective films is an optical compensation film having an optical compensating property.

(1-10) The polarizing plate described in (1-9), wherein the optical compensation film includes an optical compensation layer including an optical anisotropic layer, the optical anisotropic layer containing a compound having a discotic structural unit, in which a disc plane of the discotic structural unit is inclined to a surface of a transparent substrate of the optical compensation film, and an angle between the disc plane of the discotic structural unit and the surface of the transparent substrate changes in a direction of depth of the optical anisotropic layer.

(1-11) The polarizing plate described in (1-9), wherein the optical compensation film has a retardation Re defined by equation (II) within a range of 20 to 70 nm, a retardation Rth defined by equation (III) within a range of 70 to 400 nm, a ratio (Re/Rth) of the retardation Re and the retardation Rth within a range of 0.2 to 0.4, and a slow axis of the optical compensation film is positioned substantially parallel to a transmission axis of the polarizer:

Re=(nx−ny)×d (II)

Rth={(nx+ny)/2−nz}×d (III)

wherein nx is a refractive index in a slow axis direction in the film plane, ny is a refractive index in a fast axis direction in the film plane, nz is a refractive index in the film thickness direction, d is a film thickness, and nx, ny and nz are refractive indexes at a wavelength of 633 nm.

(1-12) An image display including an antireflection film described in any one of (1-1) to (1-7) or a polarizing plate described in any one of (1-8) to (1-11) on an outermost surface of a display.

(1-13) A liquid crystal display of a transmission, reflective or semi-reflective type of TN, STN, VA, IPS or OCB mode, including at least a polarizing plate described in any one of (1-8) to (1-11).

The present invention can also provide an antireflection film (second embodiment), a polarizing plate and an image display of configurations to be explained in the following and the aforementioned objects can be attained.

(2-1) An antireflection film comprising: a transparent substrate; a hard coat layer; and a low refractive index layer having a refractive index lower than that of the transparent substrate in this order, wherein the antireflection film has a chromaticity difference ΔEab* in a CIE1976 L*a*b* color space of 1 or less, the chromaticity difference ΔEab* being calculated by equation (II):

ΔEab*=((ΔL*)²+(Δa*)²+(Δb*)²)^{1/2}

ΔL*=L₁*−L₂*

Δa*=a₁*−a₂*

Δb*=b₁*−b₂*

wherein L₁*, a₁*, b₁* and L₂*, a₂*, b₂* are chromaticity values of a normal reflected light of the antireflection film to an incident light with an incident angle 40° under a CIE standard light source D₆₅, represented by L*, a* and b* values in the L*a*b* color space, in which L₁*, a₁* and b₁* are L*, a* and b* values of the antireflection film, respectively, before a surface at the side of the low refractive index layer is rubbed with a non-woven cloth, and L₂*, a₂* and b₂* are L*, a* and b* values of the antireflection film, respectively, after the surface at the side of the low refractive index layer is rubbed with a non-woven cloth by 200 reciprocating cycles under a load of 19.6 N/cm².

(2-2) The antireflection film described in (2-1), wherein the low refractive index layer is formed from a coating liquid including a fluorine-containing polymer that the polymer is a copolymer containing: a polymerization unit derived from a fluorine-containing vinyl monomer; and a polymerization unit having a singly crosslinkable (meth)acryloyl group in a side chain thereof, the copolymer having a main chain of only carbon atoms.

(2-3) The antireflection film described in (2-2), wherein the copolymer is a copolymer represented by formula (1):

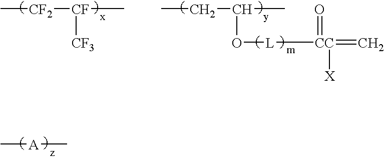

wherein L represents a divalent connecting group having 1 to 10 carbon atoms; m represents 0 or 1; X represents a hydrogen atom or a methyl group; A represents a polymerization unit derived from a vinyl monomer, which may be a single component or plural components; and x, y, z each represents a molar percentage of each constituent and satisfies conditions 30≦x≦60, 5≦y≦70 and 0≦z≦65.

(2-4) The antireflection film described in any one of (2-1) to (2-3), wherein the low refractive index layer is formed from a coating liquid containing the fluorine-containing polymer and inorganic fine particles.

(2-5) The antireflection film described in (2-4), wherein the inorganic fine particles are hollow silica fine particles having a refractive index of 1.17 to 1.40.

(2-6) The antireflection film described in any one of (2-1) to (2-5), wherein at least one of the hard coat layer and the low refractive index layer is formed from a coating liquid containing at least one of an organosilane compound, a hydrolysate thereof and a partial condensate thereof.

(2-7) The antireflection film described in any one of (2-1) to (2-6), wherein the low refractive index layer is crosslinked in an atmosphere with an oxygen concentration of 0.03% by volume or less.

(2-8) The antireflection film described in any one of (2-1) to (2-7), wherein the low refractive index layer is a layer crosslinked by irradiating with an ionizing radiation in the presence of a photopolymerization initiator and under a heating with a film surface temperature of 60° C. or higher in an atmosphere with an oxygen concentration of 0.03% by volume or less.

(2-9) A polarizing plate including: a polarizer; and two protective films, at least one of the two protective films including an antireflection film described in any one of (2-1) to (2-8).

(2-10) The polarizing plate described in (2-9), wherein one of the at least two protective films includes the antireflection film, and the other of the at least two protective films is an optical compensation film having an optical compensating property.

(2-11) The polarizing plate described in (2-10), wherein the optical compensation film includes an optical compensation layer including an optical anisotropic layer, the optical anisotropic layer containing a compound having a discotic structural unit, in which a disc plane of the discotic structural unit is inclined to a surface of a transparent substrate of the optical compensation film, and an angle between the disc plane of the discotic structural unit and the surface of the transparent substrate changes in a direction of depth of the optical anisotropic layer.

(2-12) An image display including an antireflection film described in any one of (2-1) to (2-8) or a polarizing plate described in any one of (2-9) to (2-11) on an outermost surface of a display.

(2-13) A liquid crystal display of a transmission, reflective or semi-reflective type of TN, STN, VA, IPS or OCB mode, including at least a polarizing plate described in any one of (2-9) to (1-11).

Exemplary embodiments of an antireflection film of the present invention shows a sufficient antireflective property while having an excellent scratch resistance. Also an image display provided with exemplary embodiments of the antireflection film of the invention or an image display provided with a polarizing plate utilizing exemplary embodiments of the antireflection film of the invention shows a low reflection of an external light or a low reflection of an external image, thereby exhibiting an extremely high visibility.

### BRIEF DESCRIPTION OF THE DRAWING

FIG. 1 is a schematic cross-sectional view showing a layered structure of an illustrative, non-limiting embodiments of an antireflection film of the invention.

### DETAILED DESCRIPTION OF THE INVENTION

In the following, a basic configuration of the antireflection film as an exemplary embodiment of the invention will be explained with reference to the accompanying drawings. In the present specification, a description “(numerical value 1) to (numerical value 2)” means a value equal to or larger than (numerical value 1) but equal to or smaller than (numerical value 2).

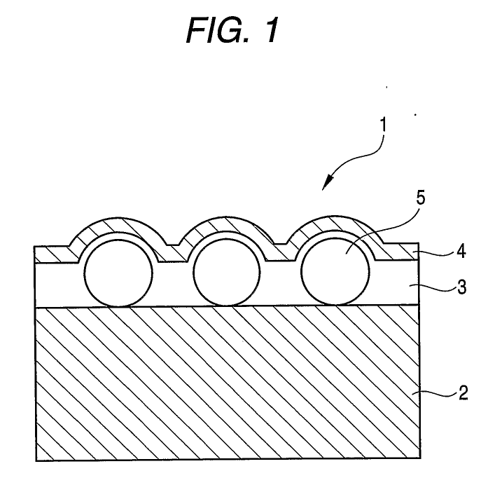

FIG. 1 is a schematic cross-sectional view of an antireflection film 1 of the invention, which has a layered structure in the order of a transparent substrate 2, an antiglare hard coat layer 3, and a low refractive index layer 4. The antiglare hard coat layer 3 contains matting particles 5 dispersed therein, and preferably has, in a material other than the matting particles 5 of the antiglare hard coat layer 3, a refractive index within a range of 1.48 to 2.00, and the low refractive index layer 4 preferably has a refractive index within a range of 1.20 to 1.49. In the present invention, the hard coat layer may be a hard coat layer having an antiglare property or a hard coat layer without an antiglare property. The low refractive index layer is coated as an outermost layer.

An antireflection film of the first embodiment of the invention preferably has a change rate of reflectance in an eraser rubbing test, calculated by equation (I), is 30% or less, more preferably 20% or less and particularly preferably 10% or less. A change rate of the reflectance of 30% or less allows to obtain a high scratch resistance.

The method of measuring the change rate of the reflectance in the aforementioned eraser rubbing test is advantageous for more exactly evaluating the scratch resistance.

The change rate of the reflectance can be approximately correlated with the result of the subjective sensual evaluation as follows.

TABLE 1

| Reflectance change rate | Result of subjective evaluation |
|---|---|
| larger than 50% | antireflection layer totally peeled off |
| larger than 40% | antireflection layer partially peeled off |
| but not exceeding 50% | |
| larger than 30% | antireflection layer not peeled off but rubbing |
| but not exceeding 40% | traces clearly observable |
| larger than 20% | rubbing traces observable but not significant |
| but not exceeding 30% | |
| larger than 10% | rubbing traces observable only under careful |
| but not exceeding 20% | observation |
| not exceeding 10% | scarce rubbing traces, observable only under |
| | bright illumination |

$$reflectance change rate ( \% ) = \frac{reflectance B - reflectance A}{reflectance A} \times 100 \qquad Equation ( 1 )$$

wherein the reflectance A indicates a reflectance of the antireflection film before rubbing a surface of a side of the low refractive index layer with an eraser, and the reflectance B is a reflectance of the antireflection film after rubbing the surface of the side of the low refractive index layer with an eraser by 50 reciprocating cycles under a load of 9.8 N/cm².

In the equation (I), the reflectances A and B are calculated in the following manner.

Reflectance A: A normal spectral reflectance at an incident angle of 5° is measured in a wavelength range of 380 to 780 nm with a spectrophotometer (V-550, manufactured by Jasco Corp.). Based on the result of measurement, an average reflectance in 450 to 650 nm is calculated as the reflectance A.

Reflectance B: On an apparatus executing a reciprocating motion at a speed of 1 m/min (surface property measuring instrument HEIDON-14, manufactured by Shinto Kagaku Co.), a rubber eraser matching “plastic eraser” defined in JIS-S-6050 (1994) and shaped into a cylindrical form of a diameter of 8 mm and a height of 5 mm is, mounted with a double-stick tape or the like, then a surface at the side of the low refractive index layer is rubbed in 50 reciprocating cycles under a load of 9.8 N/cm² and an average reflectance measured and calculated with the spectrophotometer in the same manner as described above is taken as the reflectance B.

In order to reduce a fluctuation between the erasers employed in the measurement of the reflectance B, the eraser is used after a preconditioning by rubbing a surface of another appropriate transparent substrate or another hard coat layer by 50 reciprocating cycles under a load of 9.8 N/cm². Without such pre-conditioning, the surface of the eraser shows a fluctuation in the matching with the surface and tends to result in an error.

An antireflection film of the second embodiment of the invention preferably has a difference in a chromaticity of a reflected light (a chromaticity difference ΔEab* in a CIE1976 L*a*b* color space) in a non-woven cloth rubbing test, calculated by a following equation (II) is 1 or less, more preferably 0.7 or less and particularly preferably 0.5 or less. A chromaticity difference ΔEab* in the reflected light of 1 or less allows to obtain a high scratch resistance.

The method of measuring the chromaticity difference in the non-woven cloth rubbing test is advantageous for more exactly evaluating the scratch resistance. In the non-woven cloth rubbing test featuring the invention, any non-woven cloth defined in JIS-L-0206 (1999) may be employed, for example a commercial product such as Bemcot M-3 (manufactured by Asahi Kasei Corp.). The testing method will be explained later in more details.

For calculating the chromaticity of the reflected light, there is employed a reflectance curve of a normal reflected light, but, in consideration of an actual observation of a monitor of an image display, the incident light preferably has an incident angle within a range of 5° to 45°, more preferably 30° to 45° and most preferably 40°.

The chromaticity difference ΔEab* in the reflected light can be approximately correlated with the result of the subjective sensual evaluation as follows, and it can be identified that the chromaticity difference in the reflected light is an appropriate evaluating property correctly reflecting the scratch resistance of the antireflection layer.

TABLE 2

| Chromaticity difference (ΔEab*) in | |
|---|---|
| the reflected light | Result of subjective sensual test |
| larger than 2 | scratch on antireflection layer clearly visible |
| larger than 1.5 but not exceeding 2 | scratch on antireflection layer visible |
| larger than 1 but not exceeding 1.5 | scratch on antireflection layer visible under close |
| | observation |
| larger than 0.7 but not exceeding 1 | traces visible under close observation but not |
| | significant |
| larger than 0.5 but not exceeding 0.7 | traces visible under bright illumination |
| not exceeding 0.5 | traces noticeable only in careful observation |
| | under bright illumination |

ΔEab*=((ΔL*)²+(Δa*)²+(Δb*)²)^{1/2}

ΔL*=L₁*−L₂*

Δa*=a₁*−a₂*

Δb*=b₁*−b₂* Equation (II)

wherein L₁*, a₁*, b₁* and L₂*, a₂*, b₂* are chromaticity values of a normal reflected light of the antireflection film to an incident light with an incident angle 40° under a CIE standard light source D₆₅, represented by L*, a* and b* values in the L*a*b* color space, in which L₁*, a₁* and b₁* are L*, a* and b* values of the antireflection film, respectively, before a surface at the side of the low refractive index layer is rubbed with a non-woven cloth, and L₂*, a₂* and b₂* are L*, a* and b* values of the antireflection film, respectively, after the surface at the side of the low refractive index layer is rubbed with a non-woven cloth by 200 reciprocating cycles under a load of 19.6 N/cm².

In the equation (II), L₁*, a₁*, b₁* and L₂*, a₂*, b₂* are calculated by the following methods.

L₁*, a₁*, b₁*: A normal spectral reflectance at an incident angle of 40° is measured in a wavelength range of 380 to 780 nm with a spectrophotometer (V-550, manufactured by Jasco Corp.). Then the obtained data of the spectral reflectance are multiplied with the spectral distribution data of the CIE D₆₅ standard light source for each wavelength to obtain a 400 reflected light of the irradiating light by the D₆₅ light source. Then, based on the obtained spectral reflectance data under the standard light, the L*, a* and b* values in the CIE1976 L*a*b* color space under the CIE D₆₅ standard light source are calculated to provide L₁*, a₁*, and b₁* values.

L₂*, a₂*, b₂*: On a friction element of an apparatus executing a reciprocating motion at a speed of 6 m/min (Gakushin type friction resistance tester AB-301, manufactured by Tester Sangyo Co.), a non-woven cloth matching JIS-L-0222 (1999) “non-woven cloth terms” is mounted while an antireflection film is mounted on a test piece table, then a surface at the side of the low refractive index layer is rubbed in 200 reciprocating cycles under a load of 19.6 N/cm² and L*, a*, and b* values measured and calculated with the spectrophotometer in the same manner as described above are taken as the L₂*, a₂* and b₂* values.

In order to reduce a fluctuation between the non-woven cloths employed in the measurement of the L₂*, a₂* and b₂* values, the non-woven cloth is used after a pre-conditioning by rubbing a surface of another appropriate transparent substrate or another hard coat layer by 200 reciprocating cycles under a load of 19.6 N/cm². Without such pre-conditioning, the surface of the eraser shows a fluctuation in the matching with the surface and tends to result in an error.

### (Low Refractive Index Layer)

A low refractive index layer in the antireflection film of the invention will be explained in the following.

A low refractive index layer in the antireflection film of the invention has a refractive index within a range of 1.20 to 1.49, preferably 1.30 to 1.44.

Also the low refractive index layer preferably satisfies a following relationship (IV) in order to achieve a low reflectance:

(mλ/4)×0.7<n₁d₁<(mλ/4)×1.3 (IV)

wherein m is a positive odd number; n₁ is a refractive index of the low refractive index layer; and d₁ is a thickness (nm) of the low refractive index layer. λ indicates a wavelength within a range of 500 to 550 nm n.

Meeting the relationship (IV) means that m (positive odd number, usually 1) satisfying the relationship (IV) is present within the aforementioned wavelength range.

Materials for constituting the low refractive index layer of the invention will be explained in the following.

The low refractive index layer of the invention is formed from a coating liquid containing a fluorine-containing polymer. The fluorine-containing polymer is preferably a fluorine-containing polymer crosslinkable by heat or by an ionizing radiation and having a dynamic friction coefficient of 0.03 to 0.15 and a contact to water of 90 to 120°.

Also the low refractive index layer of the invention may contain inorganic fine particles for improving the film strength.

The fluorine-containing polymer to be employed in the low refractive index layer of the invention can be a hydrolysate or dehydration condensate of a silane compound containing a perfluoroalkyl group (such as (heptadecafluoro-1,1,2,2-tetrahydrodecyl)triethoxysilane), or a fluorine-containing copolymer containing a fluorine-containing monomer unit and a constituent unit for providing a crosslinking reactivity as the constituent components.

Specific examples of the fluorine-containing monomer unit include a polymerization unit derived from a fluorine-containing vinylic monomer, for example a fluoroolefin (such as fluoroethylene, vinylidene fluoride, tetrafluoroethylene, perfluorooctylethylene, hexafluoropropylene, or perfluoro-2,2-dimethyl-1,3-dioxole), a partially or completely fluorinated alkyl ester derivative of (meth)acrylic acid (such as Viscote 6FM (trade name, manufactured by Osaka Organic Chemical Industry Ltd.) or M-2020 (trade name, manufactured by Daikin Industries Ltd.) or a completely or partially fluorinated vinyl ether, but it is preferably a perfluoroolefin and particularly preferably hexafluoropropylene in consideration of refractive index, solubility, transparency and availability.

An increased composition ratio of the fluorine-containing vinylic monomer can reduce the refractive index, but lowers the film strength. In the invention, the fluorine-containing vinylic monomer is preferably introduced in such a manner that the copolymer has a fluorine content of 20 to 60 weight %, more preferably 25 to 55 weight % and particularly preferably 30 to 50 weight %.

A constituent unit for providing the crosslinking reactivity can principally be represented by following (A), (B) and (C):

(A) a constituent unit obtained by a polymerization of a monomer having a self-crosslinking functional group in the molecule, such as glycidyl (meth)acrylate or glycidyl vinyl ether;

(B) a constituent unit obtained by a polymerization of a monomer having a carboxyl group, a hydroxyl group, an amino group or a sulfo group (such as (meth)acrylic acid, methylol (meth)acrylate, hydroxylalkyl (meth)acrylate, allyl acrylate, hydroxyethyl vinyl ether, hydroxybutyl vinyl ether, maleic acid or crotonic acid); or

(C) a constituent unit obtained by reacting a compound, having a group capable of reacting with the functional group (A) or (B) and also a crosslinking functional group within the molecule with the aforementioned unit (A) or (B) (such as a unit that can be synthesized by reacting acryl chloride with a hydroxyl group).

In the constituent unit (C) of the invention, the crosslinking functional group is preferably a photopolymerizable group. The photopolymerizable group can preferably be a (meth)acryloyl group, an alkenyl group, a cinnamoyl group, a cinnamylidenacetyl group, a benzalacetophenone group, a styrylpyridine group, an α-phenylmaleimide group, a phenylazide group, a sulfonylazide group, a carbonylazide group, a diazo group, an o-quinonediazide group, a furylacryloyl group, a coumarine group, a pyron group, an anthracene group, a benzophenone group, a stilbene group, a dithiocarbamate group, a xanthate group, a 1,2,3-thiadiazole group, a cyclopropene group, or an azadioxabicyclo group, which need not be employed singly but can be employed in two or more kinds. Among these, a (meth)acryloyl group or a cinnamoyl group is preferable, and a (meth)acryloyl group is particularly preferable.

A copolymer containing a photopolymerizable group can be synthesized for example by following methods, but they are not restrictive:

(1) a method of esterification by reacting a crosslinking functional group-containing copolymer further containing a hydroxyl group with (meth)acryl chloride;

(2) a method of urethane formation by reacting a crosslinking functional group-containing copolymer further containing a hydroxyl group with a (meth)acrylate ester containing an isocyanate group;

(3) a method of esterification by reacting a crosslinking functional group-containing copolymer further containing an epoxy group with (meth)acryl chloride; and

(4) a method of esterification by reacting a crosslinking functional group-containing copolymer further containing a carboxyl group with a (meth)acrylate ester containing an epoxy group.

An amount of introduction of the photopolymerizable group can be regulated arbitrarily, and it is also preferable to leave a certain amount of the carboxyl group or the hydroxyl group in order to stabilize a coated surface property, reduce a surface failure in the presence of in organic fine particles and to improve a film strength.

In the present specification, “(meth)acrylate”, “(meth)acryloyl” or “(meth)acrylic acid” respectively means “acrylate or methacrylate”, “acryloyl or methacryloyl” or “acrylic acid or methacrylic acid”.

In addition to the fluorine-containing monomer unit and the constituent unit for providing the crosslinking reactivity, a monomer not containing fluorine atoms may be suitably copolymerized in consideration of an adhesion to the substrate, a Tg of the polymer (contributing to the film strength), a solubility in a solvent, a film transparency, a lubricating property and a dust/smear resistance. The usable monomer is not particularly restricted, and can be, for example, an olefin (such as ethylene, propylene, isoprene, vinyl chloride, or vinylidene chloride), an acrylate ester (such as methyl acrylate, ethyl acrylate, or 2-ethylhexyl acrylate), a methacrylate ester (such as methyl methacrylate, ethyl methacrylate, butyl methacrylate or ethylene glycol dimethacrylate), a styrene derivative (such as styrene, divinylbenzene, vinyltoluene, or α-methylstyrene), a vinyl ether (such as methyl vinyl ether, ethyl vinyl ether, or cyclohexyl vinyl ether), a vinyl ester (such as vinyl acetate, vinyl propionate or vinyl cinnamate), an acrylamide (such as N-tert-butylacrylamide or N-cyclohexylacrylamide), a methacrylamide or an acrylonitrile derivative.

Such vinyl monomers may be employed in a combination of plural kinds according to the purpose, and preferably represent in total 0 to 65 mol. % of the copolymer, more preferably 0 to 20 mol. % and particularly preferably 0 to 10 mol. %.

The fluorine-containing polymer particularly useful in the invention is a random copolymer of a perfluoroolefin and a vinyl ether or a vinyl ester, having a main chain solely constituted of carbon atoms. In particular it preferably has, in a side chain, a group capable of singly executing a crosslinking reaction (preferably a radical reactive group such as (meth)acryloyl group or a ring-opening polymerizable group such as an epoxy group or an oxetanyl group, more preferably a (meth)acryloyl group). A polymerization unit containing such crosslinking reactive group preferably represents 5 to 70 mol. % of all the polymerization units of the polymer, particularly preferably 30 to 60 mol. %.

Preferred examples of the polymer include those described in JP-A Nos. 2002-243907, 2002-372601, 2003-26732, 2003-222702, 2003-294911, 2003-329804, 2004-4444 and 2004-45462.

Also in the fluorine-containing polymer of the invention, a polysiloxane structure is preferably introduced for providing a smear resistance. A method for introducing the polyxiloxane structure is not particularly restricted and is preferably introduced by a method of introducing a polysiloxane block copolymerization component utilizing a silicone macroazo initiator as described in JP-A Nos. 6-93100, 11-189621, 11-228631 and 2000-313709, or by a method of introducing a polysiloxane graft copolymerization component utilizing a silicone macromer as described in JP-A Nos. 2-251555 and 2-308806. Examples of a particularly preferable compound include polymers of examples 1, 2 and 3 in JP-A No. 11-189621, and copolymers A-2 and A-3 in JP-A No. 2-251555. Such polysiloxane component is preferably contained by 0.5 to 10 weight % in the polymer, particularly preferably 1 to 5 weight %.

The copolymer to be employed in the invention preferably has a structure shown in formula (1):

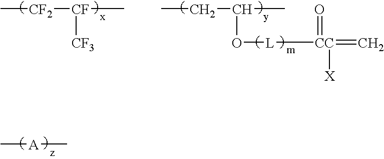

wherein L represents a divalent connecting group having 1 to 10 carbon atoms, more preferably with 1 to 6 carbon atoms and particularly preferably with 2 to 4 carbon atoms, also may be linear or branched, may have a cyclic structure or may contain a hetero atom selected from O, N and S.

Preferred examples include *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—** and *—CH₂CH₂OCONH(CH₂)₃—O—** (* representing a connecting site with a polymer main chain, and ** representing a connecting site with (meth)acryloyl group); and m represents 0 or 1.

In formula (1), X represents a hydrogen atom or a methyl group, and more preferably a hydrogen atom in consideration of a curing reactivity.

In formula (1), A represents a repeating unit derived from an arbitrary vinylic monomer, which is not particularly restricted as long as it constitutes a monomer capable of copolymerizing with hexafluoropropylene, can be suitably selected in consideration of various aspects such as an adhesion to the substrate, a Tg of the polymer (contributing to the film strength), a solubility in a solvent, a film transparency, a lubricating property and a dust/smear resistance and may be constituted of a single or plural vinylic monomers according to the purpose.

Preferred examples include a vinyl ether such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether or allyl vinyl ether; a vinyl ester such as vinyl acetate, vinyl propionate or vinyl butyrate; a (meth)acrylate such as methyl (meth)acrylate, ethyl (meth)acrylate, hydroxyethyl (meth)acrylate, glycidyl (meth)acrylate, allyl (meth)acrylate, or (meth)acryloyloxypropyl trimethoxysilane; a styrene derivative such as styrene or p-hydroxymethylstyrene; and an unsaturated carboxylic acid and a derivative thereof such as crotonic acid, maleic acid, or itaconic acid, more preferably a vinyl ether derivative and a vinyl ester derivative, and particularly preferably a vinyl ether derivative.

x, y and z each represents a molar % of each constituent component, and satisfies conditions of 30≦x≦60, 5≦y≦70 and 0≦z≦65, preferably 35≦x≦55, 30≦y≦60 and 0≦z≦20, and particularly preferably 40≦x≦55, 40≦y≦55 and 0≦z≦10.

The copolymer to be employed in the invention particularly preferably has a structure shown in formula (2):

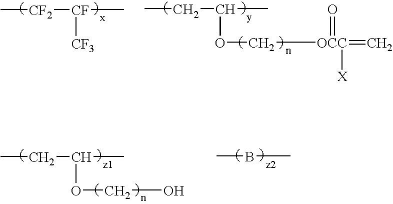

In formula 2, X, x and y have the same meanings and the same preferable ranges as in formula 1.

n represents an integer of 2≦n≦10, preferably 2≦n≦6, and particularly preferably 2≦n≦4.

B represents a repeating unit derived from an arbitrary vinylic monomer, which may be constituted of a single composition or plural compositions. Examples thereof are same as those cited for A in formula 1.

z1 and z2 each represents a molar % of each repeating unit with respect to the total repeating units constituting the polymer of formula 2, satisfying conditions 0≦z1≦65 and 0≦z2≦65, preferably 0≦z1≦30 and 0≦z2≦10, and particularly preferably 0≦z1≦10 and 0≦z2≦5.

The copolymer represented by formula 1 or 2 can be synthesized for example by introducing a (meth)acryloyl group by the aforementioned method into a copolymer including a hexafluoropropylene component and a hydroxyalkyl vinyl ether component.

In the following, preferred examples of the copolymer useful in the invention are shown but the present invention is not limited to such examples.

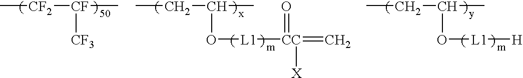

| | | | | | | Number-Averaged |
|---|---|---|---|---|---|---|
| | | | | | | Molecular Weight |
| | x | y | m | L1 | X | Mn (×10⁴) |
| P-1 | 50 | 0 | 1 | *—CH₂CH₂O— | H | 3.1 |
| P-2 | 50 | 0 | 1 | *—CH₂CH₂O— | CH₃ | 4.0 |
| P-3 | 45 | 5 | 1 | *—CH₂CH₂O— | H | 2.8 |
| P-4 | 40 | 10 | 1 | *—CH₂CH₂O— | H | 3.8 |
| P-5 | 30 | 20 | 1 | *—CH₂CH₂O— | H | 5.0 |
| P-6 | 20 | 30 | 1 | *—CH₂CH₂O— | H | 4.0 |
| P-7 | 50 | 0 | 0 | — | H | 11.0 |
| P-8 | 50 | 0 | 1 | *—C₄H₈O— | H | 0.8 |
| P-9 | 50 | 0 | 1 | 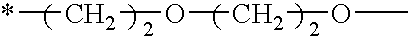 | H | 1.0 |
| P-10 | 50 | 0 | 1 | 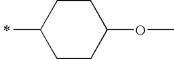 | H | 7.0 |

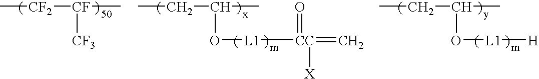

| | | | | | | Number-Averaged |
|---|---|---|---|---|---|---|
| | | | | | | Molecular Weight |
| | x | y | m | L1 | X | Mn (×10⁴) |
| P-11 | 50 | 0 | 1 | *—CH₂CH₂NH— | H | 4.0 |
| P-12 | 50 | 0 | 1 | 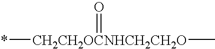 | H | 4.5 |
| P-13 | 50 | 0 | 1 | 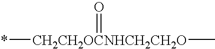 | CH₃ | 4.5 |
| P-14 | 50 | 0 | 1 | 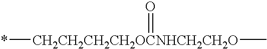 | CH₃ | 5.0 |
| P-15 | 50 | 0 | 1 | 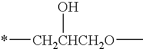 | H | 3.5 |
| P-16 | 50 | 0 | 1 | 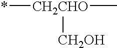 | H | 3.0 |
| P-17 | 50 | 0 | 1 | 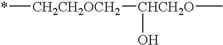 | H | 3.0 |
| P-18 | 50 | 0 | 1 | 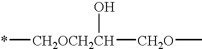 | CH₃ | 3.0 |
| P-19 | 50 | 0 | 1 | 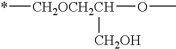 | CH₃ | 3.0 |
| P-20 | 40 | 10 | 1 | 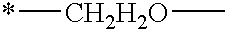 | CH₃ | 0.6 |

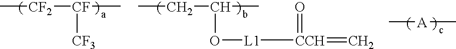

| | | | | | | Number-Averaged |
|---|---|---|---|---|---|---|
| | | | | | | Molecular Weight |
| | a | b | c | L1 | A | Mn (×10⁴) |
| P-21 | 55 | 45 | 0 | *—CH₂CH₂O—** | — | 1.8 |
| P-22 | 45 | 55 | 0 | *—CH₂CH₂O—** | — | 0.8 |
| P-23 | 50 | 45 | 5 | 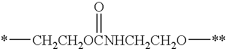 | 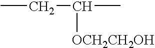 | 0.7 |
| P-24 | 50 | 45 | 5 | 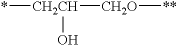 | 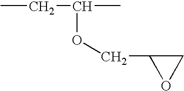 | 4.0 |
| P-25 | 50 | 45 | 5 | 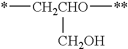 | 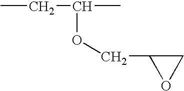 | 4.0 |
| P-26 | 50 | 40 | 10 | *—CH₂CH₂O—** | 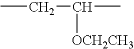 | 4.0 |
| P-27 | 50 | 40 | 10 | *—CH₂CH₂O—** | 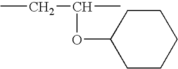 | 4.0 |
| P-28 | 50 | 40 | 10 | *—CH₂CH₂O—** | 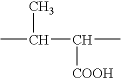 | 5.0 |

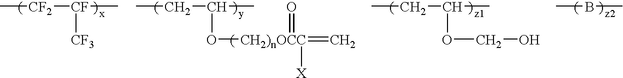

| | | | | | | | |
|---|---|---|---|---|---|---|---|
| | | | | | | | Number-Averaged |
| | | | | | | | Molecular Weight |
| x | y | z1 | z2 | n | X | B | Mn (×10⁴) |

| | | | | | | | | |
|---|---|---|---|---|---|---|---|---|
| P-29 | 50 | 40 | 5 | 5 | 2 | H | 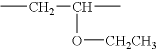 | 5.0 |
| P-30 | 50 | 35 | 5 | 10 | 2 | H | 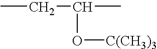 | 5.0 |
| P-31 | 40 | 40 | 10 | 10 | 4 | CH₃ | 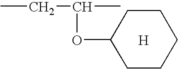 | 4.0 |

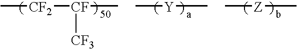

| | | | | | Number-Averaged |
|---|---|---|---|---|---|
| | | | | | Molecular Weight |
| | a | b | Y | Z | Mn (×10⁴) |
| P-32 | 45 | 5 | 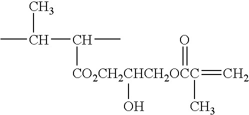 | 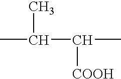 | 4.0 |
| P-33 | 40 | 10 | 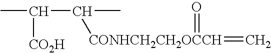 | 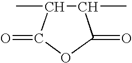 | 4.0 |

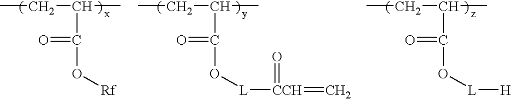

| | | | | | | Number-Averaged |
|---|---|---|---|---|---|---|
| | | | | | | Molecular Weight |
| | x | y | z | Rf | L | Mn (×10⁴) |
| P-34 | 60 | 40 | 0 | —CH₂CH₂C₈F₁₇-n | *—CH₂CH₂O— | 11 |
| P-35 | 60 | 30 | 10 | —CH₂CH₂C₄F₈H-n | *—CH₂CH₂O— | 30 |
| P-36 | 40 | 60 | 0 | —CH₂CH₂C₆F₁₂H | *—CH₂CH₂CH₂CH₂O— | 4.0 |

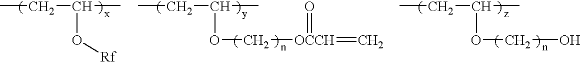

| | | | | | | Number-Averaged |
|---|---|---|---|---|---|---|
| | | | | | | Molecular Weight |
| | x | y | z | n | Rf | Mn (×10⁴) |
| P-37 | 50 | 50 | 0 | 2 | —CH₂C₄F₈H-n | 5.0 |
| P-38 | 40 | 55 | 5 | 2 | —CH₂C₄F₈H-n | 4.0 |
| P-39 | 30 | 70 | 0 | 4 | —CH₂C₈F₁₇-n | 10 |
| P-40 | 60 | 40 | 0 | 2 | —CH₂CH₂C₈F₁₆H-n | 5.0 |

*indicating polymer main chain side
**indicating acryloyl group side

The copolymer to be employed in the invention can be synthesized by a method described in JP-A No. 2004-45462.

The polymer advantageously employed in the invention has a weight-averaged molecular weight of 5,000 or more, preferably 10,000 to 500,000 and most preferably 15,000 to 200,000. It is also possible to improve a coated film surface or a scratch resistance by employing polymers of different average molecular weights in combination.

The low refractive index layer of the invention preferably includes at least a kind of inorganic fine particles.

The inorganic fine particles to be employed in the low refractive index layer will be explained.

A coating amount of the inorganic fine particles is preferably 1 to 100 mg/m², more preferably 5 to 80 mg/m², and further preferably 10 to 60 mg/m². An excessively low amount reduces an improvement on the scratch resistance, while an excessively high amount results in a formation of fine irregularities on the surface of the low refractive index layer, thus deteriorating a deep black color in display or an antireflection property.

The inorganic fine particles, being incorporated in the low refractive index layer, preferably have a low refractive index.

For example, they can be fine particles calcium fluoride or silica, and silica fine particles are preferred in consideration of a refractive index, a stability of dispersion and a cost. The silica fine particles preferably have an average particle size of 30 to 100% of the thickness of the low refractive index layer, more preferably 35 to 80% and further preferably 40 to 60%. Thus, in case the low refractive index layer has a thickness of 100 nm, the silica fine particles preferably have an average particle size of 30 to 100 nm, more preferably 35 to 80 nm and further preferably 40 to 60 nm.

An excessively small size of the silica fine particles reduces an improvement on the scratch resistance, while an excessively large particle size results in a formation of fine irregularities on the surface of the low refractive index layer, thus deteriorating a deep black color in display or an antireflection property. The silica fine particles may be crystalline or amorphous, or may be singly dispersed particles or even agglomerated particles as long as a specified particle size is satisfied. The particles most preferably have a spherical shape, but an amorphous shape is also acceptable. What have been described on silica fine particles are also applicable to other inorganic fine particles.

The average particle size of the inorganic fine particles is measured with a Coulter counter.

For further reducing an increase in the refractive index of a low refractive index layer, it is preferable to employ hollow silica fine particles, and such hollow silica fine particles preferably has a refractive index of 1.17 to 1.40, more preferably 1.17 to 1.35 and further preferably 1.17 to 1.30. The refractive index mentioned above indicates a refractive index of the entire particle, and not the refractive index of the silica in the outer shell constituting the hollow silica particles. In such particles, a cavity rate k is represented by equation (V):

k (%)=(4πa³/3)/(4πb³/3)×100

wherein a represents a radius of a cavity in a particle, and b represents a radius of an outer shell of a particle.

The cavity rate in the hollow fine particles is preferably 10 to 60%, more preferably 20 to 60% and most preferably 30 to 60%.

A change in the hollow silica particles toward a lower refractive index and a larger cavity rate results in a smaller thickness of the outer shell with a lower strength of the particles, so that, in consideration of the scratch resistance, particles of a refractive index less than 1.17 cannot be realized.

The refractive index of the hollow silica particles is measured with an Abbe's refractometer (manufactured by Atago Co.).

The silica fine particles may be subjected to a physical surface treatment such as a plasma discharge treatment or a corona discharge treatment, or a chemical surface treatment with a surfactant or a coupling agent, in order to stabilize a dispersion state in a dispersion liquid or a coating liquid and to improve an affinity and a coupling property with a binder component. It is particularly preferably to employing a coupling agent. As a coupling agent, an alkoxymetal compound (such as a titanium coupling agent or a silane coupling agent) is advantageously employed. Among these, a treatment with a silane coupling agent is particularly effective, and a silane coupling agent represented by formula (3) or (4) can be employed advantageously.

Such coupling agent is employed for executing a surface treatment prior to the preparation of the coating liquid, as a surface treating agent for the inorganic fine particles in the low refractive index layer, but it is preferably added as an additive at the preparation of the coating liquid for the low refractive index layer, thereby being contained in such layer.

The silica fine particles are preferably dispersed, prior to the surface treatment, in a medium in order to alleviate a burden of the surface treatment.

In at least either of the hard coat layer and the low refractive index layer constituting the antireflection film of the invention, a coating liquid for forming such layer preferably contains an organosilane compound and/or a hydrolysate thereof and/or a partial condensate thereof (that is, at least one of an organosilane compound, a hydrolysate thereof and a partial condensate thereof), which is so-called sol component (hereinafter represented as sol component), for the purpose of improving the scratch resistance. In particular the low refractive index layer preferably contains an organosilane compound and/or a hydrolysate thereof and/or a partial condensate thereof in order to achieve an antireflection property and a scratch resistance at the same time, and the hard coat layer preferably contains an organosilane compound, a hydrolysate or a partial condensate thereof, or a mixture thereof. In a drying/heating step of the coating liquid after coating, such sol component undergoes a condensation to form a cured substance, thereby serving as a binder for the aforementioned layer. Also in case the cured substance has a polymerizable unsaturated bond, a binder having a three-dimensional structure is formed by an irradiation of an actinic light.

The organosilane compound is preferably that represented by formula (3):

(R¹⁰)ₘ—Si(X¹)₄₋ₘ

wherein R¹⁰ represents a substituted or non-substituted alkyl group or a substituted or non-substituted aryl group; an alkyl group can be methyl, ethyl, propyl, isopropyl, hexyl, decyl, or hexadecyl and preferably has 1 to 30 carbon atoms, more preferably 1 to 16 carbon atoms and particularly preferably 1 to 6 carbon atoms; and an aryl group can be phenyl or naphthyl, preferably a phenyl group.

X¹ represents a hydroxyl group or a hydrolysable group, for example an alkoxy group (preferably with 1 to 6 carbon atoms such as a methoxy group or an ethoxy group), a halogen atom (such as Cl, Br or I), or R²COO (R² being preferably a hydrogen atom or an alkyl group with 1 to 5 carbon atoms, such as CH₃COO or C₂H₅COO), preferably an alkoxy group and particularly preferably a methoxy group or an ethoxy group.

m represents an integer of 1 to 3, preferably 1 or 2 and particularly preferably 1.

In case R¹⁰ or X¹ is present in plural units, they may be mutually same or different. A substituent contained in R¹⁰ is not particularly restricted, and can be, for example, a halogen atom (such as fluorine, chlorine or bromine), a hydroxyl group, a mercapto group, a carboxyl group, an epoxy group, an alkyl group (such as methyl, ethyl, i-propyl, propyl or t-butyl), an aryl group (such as phenyl or naphthyl), an aromatic heterocyclic group (such as furyl, pyrrazolyl or pyridyl), an alkoxy group (such as methoxy, ethoxy, i-propoxy or hexyloxy), an aryloxy group (such as phenoxy), an alkylthio group (such as methylthio or ethylthio), an arylthio group (such as phenylthio), an alkenyl group (such as vinyl or 1-propenyl), an acyloxy group (such as acetoxy, acryloyloxy, or methacryloyloxy), an alkoxycarbonyl group (such as methoxycarbonyl or ethoxycarbonyl), an aryloxycarbonyl group (such as phenoxycarbonyl), a carbamoyl group (such as carbamoyl, N-methylcarbamoyl, N,N-dimethylcarbamoyl or N-methyl-N-octylcarbamoyl), or an acylamino group (such as acetylamino, benzoylamino, acrylamino or methacrylamino), and such substituent may be further substituted.

In case R¹⁰ is present in plural units, at least one thereof is preferably a substituted alkyl group or a substituted aryl group, and particularly preferably the compound represented by formula 3 is an organosilane compound having a vinyl polymerizable substituent represented by formula (4):

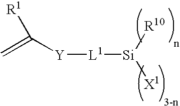

In formula (4), R¹ represents a hydrogen atom, a methyl group, a methoxy group, an alkoxycarbonyl group, a cyano group, a fluorine atom or a chlorine atom. The alkoxycarbonyl group can be a methoxycarbonyl group or an ethoxycarbonyl group. There is preferred a hydrogen atom, a methyl group, a methoxy group, a methoxycarbonyl group, cyano group, a fluorine atom or a chlorine atom, more preferably a hydrogen atom, a methyl group, a methoxycarbonyl group, a fluorine atom or a chlorine atom, and particularly preferably a hydrogen atom or a methyl group.

Y represents a single bond, *—COO—**, *—CONH—** or *—O—**, preferably a single bond, *—COO—** or *—CONH—**, further preferably a single bond or *—COO—**, and particularly preferably *—COO—**. * indicates a coupling position to ═C(R¹)—, and ** represents a coupling position to L.

L¹ represents a divalent connecting group, more specifically a substituted or non-substituted alkylene group, a substituted or non-substituted arylene group, a substituted or non-substituted alkylene group having an internal connecting group (such as ether, ester or amide), or a substituted or non-substituted arylene group having an internal connecting group, preferably a substituted or non-substituted alkylene group, a substituted or non-substituted arylene group, or a alkylene group having an internal connecting group, further preferably a non-substituted alkylene group, a non-substituted arylene group, or an alkylene group having an internal ether or ester connecting group, and particularly preferably a non-substituted alkylene group, or an alkylene group having an internal ether or ester connecting group. The substituent can be a halogen, a hydroxyl group, a mercapto group, a carboxyl group, an epoxy group, an alkyl group, or an aryl group, and such substituent may be further substituted.

n represents 0 or 1. In case X¹ is present in plural units, the plural X¹s may be mutually same or different. n is preferably 0.

R¹⁰ has the same meaning as R¹⁰ in formula 3, and is preferably a substituted or non-substituted alkyl group or a non-substituted aryl group, and more preferably a non-substituted alkyl group or a non-substituted aryl group.

X¹ has the same meaning as X¹ in formula 3, and is preferably a halogen atom, a hydroxyl group, or a non-substituted alkoxy group, more preferably a chlorine atom, a hydroxy group, or a non-substituted alkoxy group with 1 to 6 carbon atoms, further preferably a hydroxyl group or an alkoxy group with 1 to 3 carbon atoms, and particularly preferably a methoxy group.

The compound represented by formula (3) or (4) may be employed in a combination of two or more kinds. In the following, specific examples of the compounds represented by formulas (3) and (4) are shown, but these examples are not restrictive.

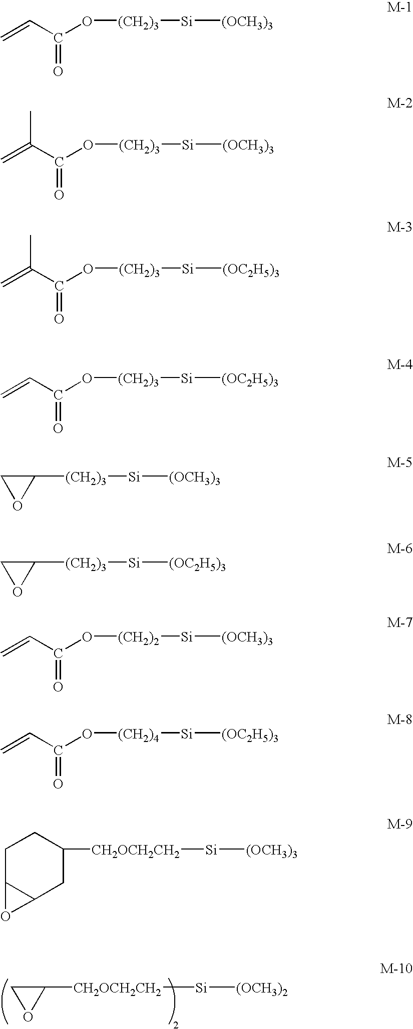

Among these example compounds, (M-1), (M-2) and (M-5) are particularly preferable.

In the following, there will be given a detailed explanation on the hydrolysate and/or partial condensate of the organosilane compound to be employed in the invention.

The hydrolysis reaction and/or condensation reaction is generally conducted in the presence of a catalyst. The catalyst can be an inorganic acid such as hydrochloric acid, sulfuric acid or nitric acid; an organic acid such as oxalic acid, acetic acid, formic acid, methanesulfonic acid or toluenesulfonic acid; an inorganic base such as sodium hydroxide, potassium hydroxide or ammonia; an organic base such as triethylamine or pyridine; a metal alkoxide such as triisopropoxy aluminum or tetrabutoxy zirconium; or a metal chelate compound having a central metal such as Zr, Ti or Al. There is preferred hydrochloric acid or sulfuric acid as an inorganic acid, or an organic acid having an acid dissociation constant in water (pKa (25° C.)) of 4.5 or less, more preferably hydrochloric acid, sulfuric acid or an organic acid having an acid dissociation constant in water of 3.0 or less, further preferably an organic acid having an acid dissociation constant in water of 2.5 or less, further preferably methanesulfonic acid, oxalic acid, phthalic acid or malonic acid, and particularly preferably oxalic acid.

The hydrolysis or condensation reaction of organosilane may be executed without a solvent or in a solvent, but an organic solvent is preferably employed for uniformly mixing the components, and is advantageously an alcohol, an aromatic hydrocarbon, an ether, a ketone or an ester.

The solvent is preferably capable of dissolving organosilane and the catalyst. Also the organic solvent is preferably employed in the process as a coating liquid or a part of the coating liquid, and, when mixed with other materials such as a fluorine-containing polymer, preferably does not deteriorate the solubility or the dispersibility thereof.

Among such materials, an alcohol can be a monohydric alcohol or a dihydric alcohol, and the monohydric alcohol is preferably a saturated aliphatic alcohol with 1 to 8 carbon atoms.

Specific examples of the alcohol include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether and ethylene glycol acetate monoethyl ether.

Also specific examples of aromatic hydrocarbon include benzene, toluene, and xylene; those of an ether include tetrahydrofuran and dioxane; those of a ketone include acetone, methyl ethyl ketone, methyl isobutyl ketone, and diisobutyl ketone; and those of an ester include ethyl acetate, propyl acetate, butyl acetate and propylene carbonate.

Such organic solvent may be employed singly or in a mixture of two or more kinds.

A solid concentration in such reaction is not particularly restricted, but is usually within a range of 1 to 90%, preferably 20 to 70%.

The reaction is conducted by adding water of 0.3 to 2 moles, preferably 0.5 to 1 mole, with respect to 1 mole of a hydrolysable group of organosilane, and executing an agitation at 25 to 100° C. in the presence of the catalyst and in the presence or absence of the solvent.

In the invention, the hydrolysis is preferably executed under agitation at 25 to 100° C., in the presence of at least a metal chelate compound having an alcohol represented by a formula R³OH (R³ represents an alkyl group with 1 to 10 carbon atoms) and a compound represented by a formula R⁴COCH₂COR⁵ (R⁴ represents an alkyl group with 1 to 10 carbon atoms; and R⁵ represents an alkyl group with 1 to 10 carbon atoms or an alkoxy group with 1 to 10 carbon atoms) as ligands and a metal selected from Zr, Ti and Al as a central metal.

As a metal chelate compound, any compound having an alcohol represented by a formula R³OH (R³ represents an alkyl group with 1 to 10 carbon atoms) and a compound represented by a formula R⁴COCH₂COR⁵ (R⁴ represents an alkyl group with 1 to 10 carbon atoms; and R⁵ represents an alkyl group with 1 to 10 carbon atoms or an alkoxy group with 1 to 10 carbon atoms) as ligands and a metal selected from Zr, Ti and Al as a central metal, may be advantageously employed without any particular restriction. Within such range, two or more metal chelate compounds may be employed in combination. The metal chelate compound to be employed in the invention is preferably selected from a group of compounds represented by formulas Zr(OR³)ₚ₁(R⁴COCHCOR⁵)ₚ₂, Ti(OR³)_{q1}(R⁴COCHCOR⁵)_{q2} and Al(CR³)ᵣ₁(R⁴COCHCOR⁵)ᵣ₂, and accelerates a condensation reaction of the hydrolysate and/or partial condensate of the organosilane compound.

In the metal chelate compound, R³ and R⁴ may be same or different, and may be an alkyl group with 1 to 10 carbon atoms, such as an ethyl group, an n-propyl group, an i-propyl group, an n-butyl group, a sec-butyl group, a t-butyl group, an n-pentyl group or a phenyl group. Also R⁵ can be an alkyl group with 1 to 10 carbon atoms as explained above, or an alkoxy group with 1 to 10 carbon atoms such as a methoxy group, an ethoxy group, an n-propoxy group, an i-propoxy group, an n-butoxy group, a sec-butoxy group, or a t-butoxy group. In the metal chelate compound, p1, p2, q1, q2, r1 and r2 are integers so determined as to satisfy p1+p2=4, q1+q2=4, and r1+r2=3.

Specific examples of the metal chelate compound include a zirconium chelate compound such as tri-n-butoxyethyl acetacetate zirconium, di-n-butoxybis(ethyl acetacetate) zirconium, n-butoxytris(ethyl acetacetate) zirconium, tetrakis(n-propyl acetacetate) zirconium, tetrakis(acetyl acetacetate) zirconium, or tetrakis(ethyl acetacetate) zirconium; a titanium chelate compound such as diisopropoxy-bis(ethyl acetacetate) titanium, diisopropoxy-bis(acetyl acetate) titanium, or diisopropoxy-bis(acetylaceton) titanium, and an aluminum chelate compound such as diisopropoxyethyl acetacetate aluminum, diisopropoxyacetyl acetonate aluminum, isopropoxybis(ethyl acetacetate) aluminum, isopropoxybis(acetyl acetonate) aluminum, tris(ethyl acetacetate) aluminum, tris(acetyl acetonate) aluminum, or monoacetyl acetonate-bis(ethyl acetacetate) aluminum.

Among these metal chelate compounds, there are preferred tri-n-butoxyethyl acetacetate zirconium, diisopropoxy-bis(acetylacetonate) titanium, diisopropoxyethyl acetacetate aluminum, and tris(ethyl acetacetate) aluminum. Such metal chelate compound may be employed singly or in a mixture of two or more kinds. Also a partial hydrolysate of such metal chelate compound is usable.

The metal chelate compound is preferably employed in a proportion of 0.01 to 50 weight % with respect to the organosilane compound, more preferably 0.1 to 50 weight % and further preferably 0.5 to 10 weight %. An amount less than 0.01 weight % may result in a slow condensation reaction of the organosilane compound, leading to a deterioration of the durability of the coated film. Also an amount exceeding 50 weight % may deteriorate a storage stability of a composition containing the hydrolysate and/or partial condensate of the organosilane compound and the metal chelate compound.

In a coating liquid for the hard coat layer and/or the low refractive index layer to be employed in the invention, a β-diketone compound and/or a β-ketoester compound is preferably added to the composition containing the hydrolysate and/or partial condensate of the organosilane compound and the metal chelate compound.

Such compounds will be explained further in the following.

In the invention, there is employed a β-diketone compound and/or a β-ketoester compound represented by a formula R⁴COCH₂COR⁵, which functions as a stability improving agent for the composition of the invention. More specifically, it is assumed to be coordinated to a metal atom in the metal chelate compound (zirconium, titanium and/or aluminum compound) to suppress a function of such metal chelate compound for accelerating the condensation reaction of the hydrolysate and/or partial condensate of the organosilane compound, thereby improving the storage stability of the obtained composition. R⁴ and R⁵ constituting the β-diketone compound and/or the β-ketoester compound are similar to R⁴ and R⁵ constituting the metal chelate compound.

Specific examples of the β-diketone compound and/or the β-ketoester compound include acetylacetone, methyl acetacetate, ethyl acetacetate, n-propyl acetacetate, i-propyl acetacetate, n-butyl acetacetate, sec-butyl acetacetate, t-butyl acetacetate, hexane-2,4-dione, heptane-2,4-dione, heptane-3,5-dione, octane-2,4-dione, nonane-2,4-dione, and 5-methyl-hexane-dione, among which ethyl acetacetate and acetylacetone are preferred and acetylacetone is particularly preferred. Such β-diketone compound and/or β-ketoester compound may be employed singly or in a mixture of two or more kinds. In the invention, the β-diketone compound and/or the β-ketoester compound is preferably employed in an amount of 2 moles or more with respect to 1 mole of the metal chelate compound, more preferably 3 to 20 moles. An amount less than 2 moles may results in an insufficient storage stability of the obtained composition.

The hydrolysate and/or partial condensate of the organosilane compound is preferably added to the low refractive index layer in an amount of 0.1 to 50 weight % of the total solids, more preferably 0.5 to 20 weight % and most preferably 1 to 10 weight %.

An amount of addition to the hard coat layer is preferably 0.001 to 50 weight % of the total solids, more preferably 0.01 to 20 weight %, further preferably 0.05 to 10 weight % and most preferably 0.1 to 5 weight %.

In the invention, it is preferable to add a liquid, which is prepared by at first forming a composition containing the hydrolysate and/or partial condensate of the organosilane compound and the metal chelate compound, and adding the β-diketone compound and/or the β-ketoester, in a coating liquid for at least either of the hard coat layer and the low refractive index layer, and to coat thus obtained coating liquid.

In the low refractive index layer, an amount of the sol component of organosilane to the fluorine-containing polymer is preferably 5 to 100 weight %, more preferably 5 to 40 weight %, further preferably 8 to 35 weight % and particularly preferably 10 to 30 weight %. An excessively low amount is difficult to attain the effect of the invention, while an excessively high amount tends to result in an increase in the refractive index or a deterioration in the form and surface state of the film.

As explained before, an addition of an additive such as a hardening agent is not necessarily advantageous for the film hardness of the low refractive index layer, but in consideration of an interfacial adhesion with the hard coat layer, there may be added a small amount of a hardening agent such as a polyfunctional (meth)acrylate compound, a polyfunctional epoxy compound, a polyisocyanate compound, an aminoplast, a polybasic acid or an anhydride thereof, or inorganic fine particles such as silica. In case of such addition, such substance is preferably added within a range of 0 to 30 weight % with respect to the total solid of the low refractive index layer, more preferably 0 to 20 weight % and particularly preferably 0 to 10 weight %.

Also an antistain agent or a lubricant of known silicone or fluorinated type may be suitably added for the purpose of providing an antistain property, a water resistance, a chemical resistance and a lubricating property. In case of such addition, such additive is preferably added within a range of 0.01 to 20 weight % with respect to the total solid of the low refractive index layer, more preferably 0.05 to 10 weight % and particularly preferably 0.1 to 5 weight %.

A preferred example of the silicone compound is a compound containing a plurality of a dimethylsilyloxy unit as a repeating unit in a compound chain and having a substituent at an end of the molecular chain and/or in a side chain.

The compound chain containing the dimethylsilyloxy group as a repeating unit may also include a structural unit other than dimethylsilyloxy. Also the substituent is preferably present in plural units, which may be mutually same or different. Preferred examples of the substituent include an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group, and an amino group. A molecular weight of the compound is not particularly restricted, but is preferably 100,000 or less, particularly preferably 50,000 or less and most preferably 3,000 to 30,000. The silicone compound is not particularly restricted in a silicon atom content, which is preferably 18.0 weight % or higher, particularly preferably 25.0 to 37.8 weight % and most preferably 30.0 to 37.0 weight %. Preferred examples of the silicone compound include X-22-174DX, X-22-2426, X-22-164B, X-22-164C, X-22-170DX, X-22-176D, and X-22-1821 (trade names, manufactured by Shin-etsu Chemical Co.), FM-0725, FM-7725, FM-4421, FM-5521, FM-6621, and FM-1121 (trade names, manufactured by Chisso Corp.), DMS-U22, RMS-033, RMS-083, UMS-182, DMS-H21, DMS-H31, HM4S-301, FMS121, FMS123, FMS131, FMS141 and FMS221 (trade names, manufactured by Gelest Inc.).

The fluorinated compound is preferably a compound having a fluoroalkyl group. The fluoroalkyl group preferably has 1 to 20 carbon atoms, more preferably 1 to 10 carbon atoms, and may have a linear structure (such as —CF₂CF₃, —CH₂(CF₂)₄H, —CH₂(CF₂)₈CF₃, or —CH₂CH₂(CF₂)₄H), a branched structure (such as —CH(CF₃)₂, —CH₂CF(CF₃)₂, —CH(CH₃)CF₂CF₃ or —CH(CH₃)(CF₂)₅CF₂H), an alicyclic structure (preferably with 5- or 6-membered ring, such as a perfluorocyclohexyl group, a perfluorocyclopentyl group or an alkyl group substituted with such group), or a structure having an ether bond (such as —CH₂OCH₂CF₂CF₃, —CH₂CH₂OCH₂C₄F₈H, —CH₂CH₂OCH₂CH₂C₈F₁₇, or —CH₂CH₂OCF₂CF₂OCF₂CF₂H). Such fluoroalkyl group may be contained in plural units within a single molecule.

The fluorinated compound preferably further includes a substituent contributing to a bond formation or a mutual solubility with the low refractive index film. The substituent is present preferably in plural units, which may be same or different. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group, and an amino group. The fluorinated compound may be a polymer or an oligomer with a compound not containing fluorine, and is not particularly restricted in the molecular weight. The fluorinated compound is not particularly restricted in a fluorine atom content, which is preferably 20 weight % or higher, particularly preferably 30 to 70 weight % and most preferably 40 to 70 weight %. Preferred examples of the fluorinated compound include R-2020, M-2020, R-3833 and M-3833 (trade names, manufactured by Daikin Industries Ltd.), Megafac F-171, F-172, F-179A and Defensa MCF-300 (trade names, manufactured by Dai-Nippon Inks and Chemicals Inc.), but these examples are not restrictive.

For the purpose of providing an antidust property and an antistatic property, an antidust agent or an antistatic agent such as a known cationic surfactant or a polyoxyalkylene compound may be suitably added. Such antidust agent or antistatic agent may also be contained as a structural unit in the aforementioned silicone compound or the fluorinated compound as a part of functions thereof. In case such substance is added as an additive, it is preferably added within a range of 0.01 to 20 weight % in all the solid of the low refractive index layer, more preferably 0.05 to 10 weight % and particularly preferably 0.1 to 5 weight %. Preferred examples of the compound include Megafac F150 (trade name, manufactured by Dai-Nippon Inks and Chemicals Inc.) and SH-3748 (trade name, manufactured by Dow Corning Toray Co.), but these examples are not restrictive.

A composition for forming the low refractive index layer of the invention is usually prepared as a liquid, by dissolving the aforementioned copolymer as an essential component, and, if necessary, other additives and a radical polymerization initiator in an appropriate solvent. A solid concentration is suitable selected according to the purpose and is generally about 0.01 to 60 weight %, preferably 0.05 to 50 weight %, particularly preferably 0.1 to 20 weight % and most preferably 1 to 10 weight %.

Curing of the low refractive index layer of the invention can be by an irradiation with an ionizing radiation or by heating, in the presence of a photoradical initiator or a thermal radical initiator.

A photoradical polymerization initiator can be an oxime ester, an acetophenone, a benzoin, a benzophenone, a phosphine oxide, a ketal, an anthraquinone, a thioxanthone, an azo compound, a peroxide, a 2,3-dialkyldione, a disulfide, a fluoroamine or an aromatic sulfonium. Examples of an oxime ester include 4-phenylsulfanylbenzaldehyde=oxime-o-acetate and 2,4-dimethyl-6-methylsulfanylbenzaldehyde-oxime-o-benzoate. Examples of an acetophenone include 2,2-diethoxyacetophenone, p-dimethylacetophenone, 1-hydroxydimethyl phenyl ketone, 1-hydroxycyclohexyl phenyl ketone, 2-methyl-4′-methylthio-2-morpholino propiophenone and 2-benzyl-2-dimethylamino-4′-morpholino butyrophenone. Examples of a benzoin include benzoin benzenesulfonate ester, benzoin toluenesulfonate ester, benzoin methyl ether, benzoin ethyl ether and benzoin isopropyl ether. Examples of a benzophenone include benzophenone, 2,4-dichlorobenzophenone, 4,4-dichlorobenzophenone and p-chlorobenzophenone. Examples of a phosphine oxide include 2,4,6-trimethylbenzoyl diphenylphosphine oxide. In particular an oxime ester and an acetophenone are preferred.

Also Kazuhiro Takausu, “Latest UV Curing Technology”, p. 159 (published by Gijutsu Joho Kyokai, 1991) describes various examples which can be useful for the invention.

Preferred examples of a commercially available photo-cleavable photoradical polymerization initiator include Irgacure (651, 184, 907) manufactured by Nippon Chiba-Geigy Ltd.

The photopolymerization initiator is preferably employed within a range 0.1 to 15 parts by weight with respect to 100 parts by weight of the polyfunctional monomer, more preferably 1 to 10 parts by weight.

A photosensitizer may be employed in addition to the photopolymerization initiator. Specific examples of the photosensitizer include n-butylamine, triethylamine, tri-n-butylphosphine, a Michler's ketone and thioxanthone.

The curing reaction of the low refractive index layer of the invention by the photoradical initiator is preferably executed in an atmosphere with an oxygen concentration of 0.03% by volume or less. A curing reaction executed in an atmosphere with an oxygen concentration of 0.03% by volume or less allows to evidently suppress a polymerization inhibiting reaction by oxygen, thereby providing a low refractive index layer with a very excellent physical strength.

The curing reaction is more preferably executed in an atmosphere with an oxygen concentration of 0.01% by volume or less, further preferably in an atmosphere with an oxygen concentration of 0.005% by volume or less, and particularly preferably in an atmosphere with an oxygen concentration of 0.001% by volume or less.

An oxygen concentration of 0.03% by volume or less is obtained preferably by substituting the air (with a nitrogen concentration of about 79% by volume and an oxygen concentration of about 21% by volume) with another gas, particularly preferably with nitrogen (nitrogen purging).

The ionizing irradiation is preferably executed with a high pressure mercury lamp or a metal halide lamp. An irradiating energy is only required to be in an amount causing a sufficient curing reaction, and, more specifically, is preferably within a range of 50 to 1500 mJ/cm², more preferably within a range of 50 to 1000 mJ/cm², and particularly preferably within a range of 100 to 800 mJ/cm².

At the execution of the curing reaction under the irradiation with the ionizing radiation, the film surface temperature is preferably as high as possible, but in practice, an upper limit temperature is determined by the heat resistance of the transparent substrate. More specifically, the temperature is within a range of 60 to 120° C., more preferably 70 to 110° C. and particularly preferably 80 to 100° C.

In order to achieve a sufficient curing reaction, the atmosphere with an oxygen concentration of 0.03% or less is preferably maintained for a certain time after the irradiation with the ionizing radiation. There is only required a time which causes the curing reaction to proceed sufficiently, preferably 0.1 seconds or more, more preferably 0.3 seconds or more and particularly preferably 0.5 seconds or more.

The low refractive index layer preferably has a haze of 3% or less, more preferably 2% or less and most preferably 1% or less.

The low refractive index layer preferably has a strength of H or higher in a pencil hardness test according to JIS-K-5600-5-4, more preferably 2H or higher and most preferably 3H or higher.

Also in order to improve an antistain property of the optical film, it preferably has a contact angle of the surface to water of 90° or higher, more preferably 95° or higher and particularly preferably 100° or higher.

(Hard Coat Layer)

A hard coat layer of the invention will be explained in the following.

A binder for forming the hard coat layer of the invention is preferably a polymer having a saturated hydrocarbon chain or a polyether chain as a main chain, and more preferably a polymer having a saturated hydrocarbon chain. Also the binder polymer preferably has a crosslinked structure.

The binder polymer having a saturated hydrocarbon chain as a main chain is preferably a polymer of an ethylenic unsaturated monomer. Also the binder polymer having a saturated hydrocarbon chain as a main chain and having a crosslinked structure is preferably a (co)polymer of a monomer having two or more ethylenic unsaturated groups.

In order to attain a higher refractive index in the hard coat layer, the monomer preferably includes, in its structure, an aromatic ring or at least an atom selected from a halogen atom other than a fluorine atom, a sulfur atom, a phosphor atom and a nitrogen atom.

Examples of a monomer having two or more ethylenic unsaturated groups include an ester of a polyhydric alcohol and (meth)acrylic acid (such as ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyactylate, or polyester polyacrylate), vinylbenzene and a derivative thereof (such as 1,4-divinylbenzene, 4-vinylbenzoic acid-2-acryloylethyl ester, or 1,4-divinylcyclohexanone), a vinylsulfone (such as divinylsulfone), an acrylamide (such as methylenebisacrylamide) and a methacrylamide. Such monomer may be employed in a combination of two or more kinds.

Specific examples of the high refractive index monomer include bis(4-methacryloylthiophenyl) sulfide, vinylnaphthalene, vinylphenyl sulfide and 4-methacryloxyphenyl-4′-methoxyphenyl thioether. Such monomer can also be employed in a combination of two or more kinds.

Polymerization of such monomer having ethylenic unsaturated groups can be executed by an irradiation with an ionizing radiation or by heating, in the presence of a photoradical initiator or a thermal radical initiator.

A thermal radical initiator can be an organic or inorganic peroxide, an organic azo or diazo compound.

Specific examples of an organic peroxide include benzoyl peroxide, halogenated benzoyl peroxide, lauroyl peroxide, acetyl peroxide, dibutyl peroxide, cumene hydroperoxide, or butyl hydroperoxide; those of an inorganic peroxide include hydrogen peroxide, ammonium persulfate and potassium persulfate; those of an azo compound include 2,2′-azobis(isobutyronitrile), 2,2′-azobis(propionitrile) and 1,1′-azobis(cyclohexanecarbonitrile); and those of a diazo compound include diaminobenzene, and p-nitrobenzene diazonium.

A polymer having a polyether as a main chain is preferably a ring-opening polymer of a polyfunctional epoxy compound. A ring-opening polymerization of the polyfunctional epoxy compound can be executed by an irradiation with an ionizing radiation or by heating, in the presence of a photoacid generating agent or a thermal acid generating agent.

Therefore, the hard coat layer can be formed by preparing a coating liquid containing a polyfunctional epoxy compound, a photoacid generating agent or a thermal acid generating agent, matting particles and inorganic fine particles, coating such coating liquid on a transparent substrate, and curing the coated layer by a polymerization reaction by an ionizing radiation or by heat.

It is also possible to employ a monomer having a crosslinking functional group, instead of or in addition to a monomer having two or more ethylenic unsaturated groups, thereby introducing a crosslinkable functional group in the polymer, and, utilizing a function of such crosslinkable functional group, to introduce a crosslinked structure into the binder polymer.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also vinylsulfonic acid, an acid anhydride, a cyanoacrylate derivative, melamine, etherified methylol, an ester, an urethane or a metal alkoxide such as tetramethoxysilane can be utilized as a monomer for introducing a crosslinked structure. There can also be employed a functional group capable of showing a crosslinking property as a result of a decomposition reaction, such as block isocyanate group. Thus, in the invention, the crosslinking functional group need not necessarily be a group immediately capable of a reaction but showing a reactivity after a decomposition reaction.

The binder polymer having such crosslinking functional group can form a crosslinked structure by heating after coating.

In the hard coat layer of the invention, for the purpose of regulation of the refractive index prevention of shrinkage at the crosslinking, and increase in the strength, there are preferably contained inorganic fine particles.

For increasing the refractive index, there are preferably contained inorganic fine particles constituted of at least an oxide of a metal selected from titanium, zirconium, aluminum, indium, zinc, tin and antimony and having an average particle size of 0.2 μm or less, preferably 0.1 μm or less and further preferably 0.06 μm or less.

Also in order to reduce a difference in the refractive index silicon oxide may also be employed. A preferred particle size is same as that of the inorganic filler.

Specific examples of the inorganic fine particles to be employed in the hard coat layer include TiO₂, ZrO₂, Al₂O₃, In₂O₃, ZnO, SnO₂, Sb₂O₃, ITO and SiO₂. TiO₂ and ZrO₂ are particularly preferable in obtaining a high refractive index. The inorganic fine particles are also preferably subjected, on the surface thereof, to a silane coupling treatment or a titanium coupling treatment, and a surface treating agent having a functional group capable of reacting with the binder is preferably employed on the surface of the fine particles.

An amount of such inorganic fine particles is preferably 10 to 90% by weight of the total weight of the hard coat layer, more preferably 20 to 80% by weight and particularly preferably 30 to 75% by weight.

Such inorganic fine particles do not cause a light scattering as its particle size is sufficiently smaller than a wavelength of the light, and a dispersion formed by dispersing such inorganic fine particles in the binder polymer behaves as an optically uniform medium.

A bulk refractive index of the mixture of the binder and the inorganic fine particles of the hard coat layer of the invention is preferably 1.48 to 2.00, more preferably 1.50 to 1.80.

A refractive index within such range can be realized by suitably selecting types and proportions of the binder and the inorganic fine particles. Such selection can be easily made by executing an experiment in advance.

In the hard coat layer of the invention, in order to secure a surface uniformity, for example against a coating unevenness, a drying unevenness or a point defect, a surfactant of fluorine type and/or silicone type is preferably contained in a coating composition for forming the hard coat layer. Particularly a fluorinated surfactant is employed preferably as it is effective, with a smaller amount of addition, in improving a surface failure such as a coating unevenness, a drying unevenness or a point defect in the antireflection film of the invention.

It is employed for providing an adaptability to a high-speed coating, thereby improving the productivity.

A preferred example of the surfactant of fluorine type is a copolymer containing a fluoroaliphatic group (also abbreviated as “fluorinated polymer”), and, as such fluorinated polymer, there is advantageously employed an acrylic resin or a methacrylic resin containing a repeating unit corresponding to a following monomer (i) and a repeating unit corresponding to a following monomer (ii), or a copolymer with a vinylic monomer capable of copolymerization with such monomers.

(i) Monomer containing fluoroaliphatic group represented by formula (5):

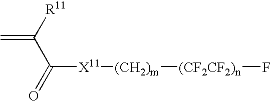

In formula (5), R¹¹ represents a hydrogen atom or a methyl group; X¹¹ represents an oxygen atom, a sulfur atom or —N(R¹²); and m preferably represents an integer of 1 to 6, particularly preferably 2.

n represents an integer of 1 to 3; R¹² represents a hydrogen atom, or an alkyl group with 1 to 4 carbon atoms, specifically a methyl group, an ethyl group, a propyl group or a butyl group, preferably a hydrogen atom or a methyl group; and X¹¹ is preferably an oxygen atom.

In formula (5), n represents an integer of 1 to 3, and there may be employed a mixture of n of 1 to 3.

(ii) A monomer represented by formula (6), copolymerizable with the monomer (i):

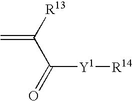

In formula (6), R¹³ represents a hydrogen atom or a methyl group; Y¹ represents an oxygen atom, a sulfur atom or —N(R¹⁵)—; R¹⁵ represents a hydrogen atom or an alkyl group with 1 to 4 carbon atoms, specifically a methyl group, an ethyl group, a propyl group or a butyl group, preferably a hydrogen atom or a methyl group; and Y¹ is preferably an oxygen atom, —N(H)— or —N(CH₃)—.

R¹⁴ represents a linear, branched or cyclic alkyl group with 4 to 20 carbon atoms that may have a substituent. The substituent of alkyl group represented by R¹⁴ can be a hydroxyl group, an alkylcarbonyl group, an arylcarbonyl group, a carboxyl group, an alkylether group, an arylether group, a halogen atom such as a fluorine atom, a chlorine atom or a bromine atom, a nitro group, a cyano group or an amino group, but these examples are not exhaustive. The linear, branched or cyclic alkyl group with 4 to 20 carbon atoms can be a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group or an eicosanyl group any of which may be linear or branched; a monocycloalkyl group such as a cyclohexyl group or a cycloheptyl group; or a polycycloalkyl group such as a bicycloheptyl group, a bicyclodecyl group, a tricycloundecyl group, tetracyclododecyl group, an adamantyl group, a norbornyl group or a tetracyclodecyl group.

An amount of the monomer containing the fluoroaliphatic group represented by formula (5), to be employed in the fluorinated polymer in the invention is 10 mol. % or more with respect to the monomers in the fluorinated polymer, preferably 15 to 70 mol. % and more preferably 20 to 60 mol. %.

The fluorinated polymer to be employed in the present invention preferably has a weight averaged molecular weight of 3,000 to 100,000, more preferably 5,000 to 80,000.

Also a preferred amount of addition of the fluorinated polymer in the invention is within a range of 0.001 to 5 weight % with respect to the coating liquid, preferably 0.005 to 3 weight % and more preferably 0.01 to 1 weight %. An amount of the fluorinated polymer less than 0.001 weight % results in an insufficient effect, while an amount exceeding 5 weight % results in an insufficient drying of the coated film or a detrimental effect on the performance of the coated film (such as a reflectance or a scratch resistance).

In the following, examples of the structure of the fluorinated polymer in the invention are shown but the invention is not limited to such examples. A number in formula indicates a molar ratio of each monomer component, and Mw represents a weight-averaged molecular weight.

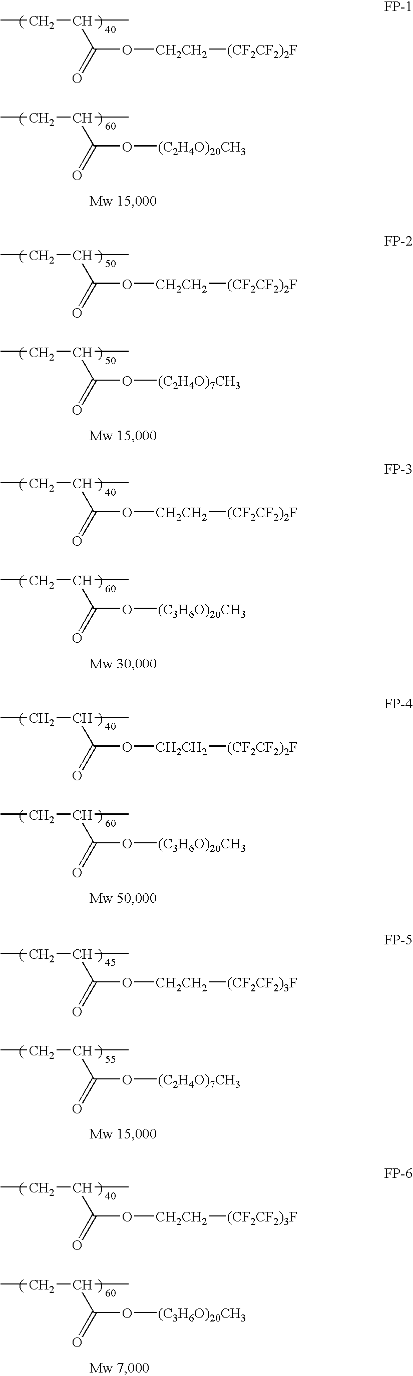

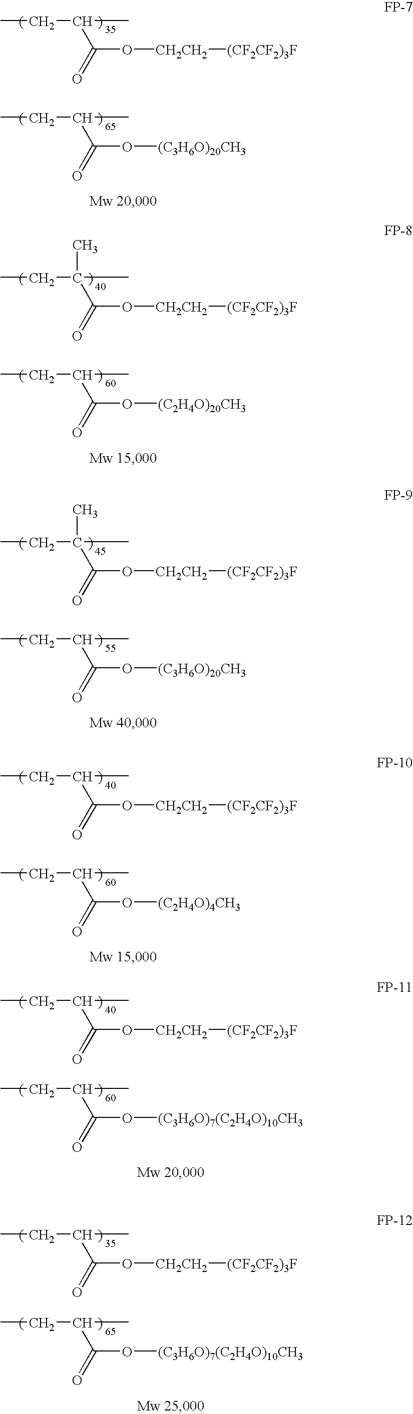

However, in the use of the fluorinated polymer, a functional group containing a fluorine atom is segregated on the surface of the hard coat layer to lower the surface energy thereof, thereby deteriorating the antireflective ability when the low refractive index layer is overcoated. This is presumably due to a fact that a coating composition employed for forming the low refractive index layer is deteriorated in the wetting property, thereby resulting in minute unevenness, undetectable in visual observation, in the thickness of the low refractive index layer. For solving such drawback, it is found effective to control the surface energy of the hard coat layer, by regulating a structure and an amount of the fluorinated polymer, preferably at 20 to 50 mN/m, more preferably 30 to 40 mN/m. Also for realizing such surface energy, a ratio F/C of a peak derived from fluorine atom and a peak derived from carbon atom in an X-ray photoelectron spectroscopy is required to be 0.1 to 1.5.

Also a deterioration in the antireflection property can be avoided by preventing a loss of the surface energy at the overcoating of the low refractive index layer on the hard coat layer. Such object can also be attained by employing the fluorinated polymer at the coating of the hard coat layer to reduce the surface tension of the coating liquid thereby improving uniformity of the surface property and maintaining a high productivity by a high-speed coating, and by executing, after the coating of the hard coat layer, a surface treatment such as a corona treatment, a UV treatment, a heat treatment, a saponification treatment or a solvent treatment, preferably a corona treatment, to prevent a loss of the surface free energy thereby controlling the surface energy of the hard coat layer prior to the coating of the low refractive index layer.

The hard coat layer may include, for the purpose of providing an antiglare property or an internal scattering property, matting particles larger than the inorganic fine particles and having an average particle size of 1.0 to 10.0 μm, preferably 1.5 to 7.0 μm, such as particles of an inorganic compound or resin particles.

Specific preferred examples of the matting particles include particles of an inorganic compound such as silica particles, or TiO₂ particles; and resin particles such as acryl particles, crosslinked acryl particles, polystyrene particles, crosslinked styrene particles, melamine resin particles, or benzoguanamine resin particles. Among these crosslinked styrene particles, crosslinked acryl particles, or silica particles are preferred.

The matting particles may have a spherical or amorphous shape.

Also there may be employed matting particles of two or more kinds of different particle sizes. It is also possible to provide an antiglare property with the matting particles of a larger particle size and to provide another optical property with the matting particles of a smaller particle size. For example, in case of applying an optical film on a high-definition display of 133 ppi or higher, there may result a defect in the image quality, called “glittering”. Such glittering is caused by a fact that pixels are enlarged or contracted by irregularities present on the film surface, whereby the luminance loses uniformity, but such phenomenon can be significantly alleviated by employing matting particles, smaller than the matting particles providing the antiglare property and having a refractive index different from that of the binder.

A particle size distribution of the matting particles is most preferably a single dispersion, and the particles preferably are as mutually close as possible in size. By defining a particle having a size larger by 20% or more than an average particle size as a coarse particle, a proportion of such coarse particles is preferably 1% or less of a number of all the particles, more preferably 0.1% or less and further preferably 0.01% or less. Matting particles having such particle size distribution can be obtained by executing a classification after an ordinary synthesizing reaction, and matting particles of a more preferable distribution can be obtained for example by increasing the number of classifications or by increasing a level thereof.

Such matting particles are contained in the hard coat layer in such a manner that an amount of the matting particles therein is preferably 10 to 1000 mg/m², more preferably 100 to 700 mg/m².

A particle size distribution of the matting particles is measured by a Coulter counter and is converted into a number distribution of the particles.

The hard coat layer preferably has a film thickness of 1.0 to 10.0 μm, more preferably 1.2 to 7.0 μm.

The hard coat layer preferably has a strength of H or higher in a pencil hardness test according to JIS-K-5600-5-4, more preferably 2H or higher and most preferably 3H or higher.

In case the hard coat layer is formed by a crosslinking reaction of a compound curable with an ionizing radiation or by a polymerization reaction, such crosslinking reaction or polymerization reaction is preferably executed in an atmosphere with an oxygen concentration of 10% by volume or less. A layer formation executed in an atmosphere with an oxygen concentration of 10% by volume or less allows to obtain a hard coat layer excellent in the physical strength and the chemical resistance.

The hard coat layer is preferably formed by a crosslinking reaction of a compound curable with an ionizing radiation or by a polymerization reaction in an atmosphere with an oxygen concentration of 6% or less, more preferably in an atmosphere with an oxygen concentration of 2% or less, particularly preferably in an atmosphere with an oxygen concentration of 1% or less, and most preferably in an atmosphere with an oxygen concentration of 0.1% or less.

An oxygen concentration of 10% or less is obtained, as described before, preferably by substituting the air with another gas, particularly preferably with nitrogen.

The irradiation of the ionizing radiation is preferably executed with a high pressure mercury lamp or a metal halide lamp. An irradiating energy is only required to be in an amount causing a sufficient curing reaction, and, more specifically, is preferably within a range of 50 to 1,500 mJ/cm², more preferably within a range of 50 to 1,000 mJ/cm², and particularly preferably within a range of 100 to 800 mJ/cm².

In order to accelerate the curing, it is also preferable to execute heating simultaneously with or after the irradiation with the ionizing radiation. In case of heating, a temperature range of about 30 to 200° C. is preferable, more preferably 80 to 180° C. and particularly preferably 100 to 150° C. A heating time is preferably 30 seconds to 100 hours, more preferably 1 minute to 1 hour, and particularly preferably 2 to 15 minutes.

A heating method is not particularly restricted, and there is preferably utilized a method of contacting a heated roll with a web, a method of blowing heated nitrogen, or a far infrared or infrared irradiation. There can also be utilized a method of heating a rotary metal roll by passing a medium such as warm water, steam or oil, as described in Japanese Patent No. 2523574. Also an induction heated roll can be employed as means of heating.

The hard coat layer is preferably formed by coating a coating composition for forming a hard coat layer, on a transparent substrate.

The coating liquids for forming the hard coat layer and the low refractive index layer of the invention preferably employs a ketone solvent, which may be employed singly or in a mixture, and, in case of a mixture, the ketone solvent has a content of 10 weight % or higher in all the solvents contained in the coating composition, preferably 30 weight % or higher and further preferably 60 weight % or higher.

The coating solvent may contain a solvent other than the ketone solvent. Examples of such solvent with a boiling point of 100° C. or lower include a hydrocarbon such as hexane (boiling point 68.7° C., hereinafter “° C.” being omitted), heptane (98.4), cyclohexane (80.7) or benzene (80.1); a halogenated hydrocarbon such as dichloromethane (39.8), chloroform (61.2), carbon tetrachloride (76.8), 1,2-dichloroethane (83.5), or trichloroethylene (87.2); an ether such as diethyl ether (34.6), diisopropyl ether (68.5), dipropyl ether (90.5), or tetrahydrofuran (66); an ester such as ethyl formate (54.2), methyl acetate (57.8), ethyl acetate (77.1), or isopropyl acetate (89); a ketone such as acetone (56.1), or 2-butanone (same as methyl ethyl ketone; 79.6); an alcohol such as methanol (64.5), ethanol (78.3), 2-propanol (82.4) or 1-propanol (97.2); and a cyano compound such as acetonitrile (81.6) or propionitrile (97.4); and carbon disulfide (46.2). Among these a ketone or an ester is preferable, and particularly a ketone, in which 2-butanone is particularly preferred.

Examples of solvent with a boiling point of 100° C. or higher include octane (125.7), toluene (110.6), xylene (138), tetrachloroethylene (121.2), chlorobenzene (131.7), dioxane (101.3), dibutyl ether (142.4), isobutyl acetate (118), cyclohexanone (155.7), 2-methyl-4-pentanone (MIBK or methyl isobutyl ketone; 115.9), 1-butanol (117.7), N,N-dimethylformamide (153), N,N-dimethylacetamide (166), and dimethyl sulfoxide (189), among which preferred is cyclohexanone or 2-methyl-4-pentanone.

A coating liquid for the hard coat layer or the low refractive index layer of the invention is prepared by diluting the components of such layer with a solvent of the aforementioned structure. A concentration of the coating liquid is suitably regulated in consideration of a viscosity of the coating liquid and a specific gravity of materials constituting the layer, and is generally within a range of about 0.01 to 60 weight %, preferably 0.05 to 50 weight %, particularly preferably 0.1 to 20 weight % and most preferably 1 to 10 weight %.

As a transparent substrate for the antireflection film of the invention, a plastic film is preferably employed. A polymer constituting the plastic film can be a cellulose acylate (for example triacetyl cellulose or diacetyl cellulose, representatively TAC-TD80U or TD80UF manufactured by Fuji Photo Film Co.), polyamide, polycarbonate, polyester (such as polyethylene phthalate or polyethylene naphthalate), polystyrene, polyolefin, a norbornene resin (such as Arton (trade name) manufactured by JSR Corp.), or amorphous polyolefin (such as Zeonex (trade name) manufactured by Nippon Zeon Corp.). Among these, triacetyl cellulose, polyethylene terephthalate or polyethylene naphthalate is preferable, and triacetyl cellulose is particularly preferable.

The cellulose acylate solution may be constituted of a single layer or plural layers. A single-layered triacetyl cellulose film is prepared by a drum casting method disclosed for example in JP-A No. 7-11055, or a band casting method, and a plural-layered triacetyl cellulose film is prepared by so-called co-casting method described for example in JP-A No. 61-94725 and JP-B No. 62-43846. Such methods are executed by dissolving flakes of a raw material in a solvent such as a halogenated hydrocarbon (such as dichloromethane), an alcohol (such as methanol, ethanol or butanol), an ester (methyl formate or methyl acetate), or an ether (dioxane, dioxolane or diethyl ether), then adding if necessary various additives such as a plasticizer, an ultraviolet absorber, an antiaging agent, a lubricant or a peeling promoter to obtain a solution (called dope), then casting such dope on a substrate constituted of a horizontal endless metal belt or a rotating drum from dope supply means (called a die), by a single-layer casting of a dope in case of a single-layered film or by a co-casting of a cellulose acylate dope of a high concentration and dopes of a low concentration on both sides thereof, then peeling, from the substrate, a film having a certain rigidity after a drying of a certain extent on the substrate and passing the film by various conveying means through a drying section thereby eliminating the solvent.

For dissolving cellulose acylate, dichloromethane is employed as a representative solvent. However, in consideration of a global environment or a work environment, the solvent is preferably substantially free from a halogenated hydrocarbon such as dichloromethane. “Substantially free” means that a proportion of the halogenated hydrocarbon in the organic solvent is less than 5 weight % (preferably less than 2 weight %).

For preparing a dope of cellulose acylate with a solvent substantially free from dichloromethane or the like, there is necessitated a special dissolving method as explained in the following.

A first dissolving method is called a cooled dissolving method, which is explained in the following. At first cellulose acylate is gradually added under agitation in a solvent, at a temperature close to the room temperature (−10 to 40° C.).

Then the mixture is cooled to −100 to −10° C. (preferably −80 to −10° C., more preferably −50 to −20° C. and most preferably −50 to −30° C.). The cooling can be executed for example in a dry ice-methanol bath (−75° C.) or a cooled diethylene glycol solution (−30 to −20° C.). The mixture of cellulose acylate and solvent solidifies under such cooling. It is then heated to a temperature of 0 to 200° C. (preferably 0 to 150° C., more preferably 0 to 120° C. and most preferably 0 to 50° C.) to obtain a solution in which cellulose acylate flows. The heating can be achieved by a standing in the room temperature, or by a heating in a heated bath.

A second dissolving method is called a high-temperature dissolving method, which is explained in the following. At first cellulose acylate is gradually added under agitation in a solvent, at a temperature close to the room temperature (−10 to 40° C.).

In the cellulose acylate solution of the invention, it is preferable to swell the cellulose acylate in advance by adding it in a mixed solvent containing various solvent. In this method, a concentration of the cellulose acylate is preferably 30 weight % or less, but, in consideration of a drying efficiency in the film casting, is preferably as high as possible. Then the mixture in the mixed solvent is heated under an elevated pressure of 0.2 to 30 MPa at 70 to 240° C. (preferably 80 to 220° C., more preferably 100 to 200° C. and most preferably 100 to 190° C.). Then such heated solution, which cannot be coated in such state, has to be cooled to a temperature lower than the lowest boiling point among the employed solvents. It is generally conducted to cool to a temperature of −10 to 50° C. and to reduce the pressure to the normal pressure. The cooling can be achieved by leaving a high-pressure high-temperature container or a line, containing the cellulose acylate solution, at the room temperature or by cooling such apparatus with a coolant such as cooling water. A cellulose acylate film substantially free from a halogenated hydrocarbon such as dichloromethane and a producing method thereof are described in detail in the Japan Institute of Invention and Innovation, Laid-open Technical Report (2001-1745, issued Mar. 15, 2001) (hereinafter abbreviated as Laid-open Technical Report 2001-1745).

The antireflection film of the invention, in case applied to a liquid crystal display, is provided on an outermost surface of the display for example by forming an adhesive layer on a side. It can also be employed in combination with a polarizing plate. In case the transparent substrate is formed by triacetyl cellulose, since triacetyl cellulose is employed as a protective film for a polarizing layer of a polarizing plate, it is advantageous in cost to employ the antireflection film of the invention as the protective film.

The antireflection film of the invention, in case provided on the outermost surface of a display for example by forming an adhesive layer on a side, or in case employed as a protective film of the polarizing plate, is preferably subjected to a saponification process for achieving a sufficient adhesion, after an outermost layer (antireflective layer) principally constituted of a fluorine-containing polymer is formed on the transparent substrate. The saponification process is executed by a known method, such as an immersion of the film in an alkali solution for a suitable time. After the immersion in the alkali solution, the film is preferably washed sufficiently with water or immersed in a dilute acid to neutralize the alkali component in order that the alkali component does not remain in the film.

The saponification process renders a surface of the transparent substrate, opposite to a side having the outermost layer, hydrophilic.

The hydrophilic surface is particularly effective for improving an adhesive property to a polarizing film principally constituted of polyvinyl alcohol. Also the hydrophilic surface, retarding deposition of dusts in the air, hinders entry of dusts between the polarizing film and the optical film at the adhesion to the polarizing film and is thus effective for preventing a point-shaped defect caused by dusts.

The saponification process is preferably executed in such a manner that a surface of the transparent substrate, opposite to the side having the outermost layer, has a contact angle to water of 40° or less, more preferably 30° or less and particularly preferably 20° or less.

A specific method of the saponification process can be selected from following methods (1) and (2). The method (1) is superior in that the process can be executed in the same manner as in the ordinary triacetyl cellulose film, but saponifies also the surface of the antireflection film, thus possibly leading to defects that the film is deteriorated by an alkaline hydrolysis of the surface and that a stain may be formed by the eventually remaining saponifying solution. In such case, the method (2) is superior though it requires a particular process:

(1) After the antireflection layer is formed on the transparent substrate, the film is immersed at least once in an alkali solution whereby a rear surface of the film is saponified:

(2) Before or after the antireflection layer is formed on the transparent substrate, an alkali solution is coated on a surface of the antireflection film, opposite to a surface thereof bearing the antireflection layer, then heated, washed with water and/or neutralized whereby the film is saponified only on the rear surface thereof.

The antireflection film of the invention can be prepared by a following method, but the present invention is not limited to such method.

At first a coating liquid containing components for forming each layer is prepared. Then a coating liquid for forming a hard coat layer is coated on a transparent substrate by a dip coating method, an air-knife coating method, a curtain coating method, a roller coating method, a dip coating method, a wired bar coating method, a gravure coating method or an extrusion coating method (described in U.S. Pat. No. 2,681,294), and heat dried. Among these coating methods, a gravure coating method and an extrusion coating method are preferable, and a micro gravure coating method is particularly preferable. Thereafter, a light irradiation or a heating is executed to polymerize and cure the monomer for forming the hard coat layer, which is thus completed.

If necessary, the hard coat layer may be formed in plural layers, and, after the coating of the hard coat layer, an antiglare hard coat layer may be coated and cured in a similar manner.

Then a coating liquid for forming a low refractive index layer is coated on the hard coat layer and is subjected to a light irradiation or a heat to obtain a low refractive index layer. An antireflection film of the invention can thus be obtained.

The micro gravure coating method to be employed in the invention is conducted by rotating, under the substrate and in a direction opposite to the transporting direction thereof, a gravure roll having a diameter of about 10 to 100 mm, preferably about 20 to 50 mm, and bearing a gravure pattern over the entire periphery, then by scraping off an excessive coating liquid from the surface of such gravure roll with a doctor blade and by transferring the coating liquid to a lower surface of the substrate in a position where an upper surface thereof is maintained in a free state. At least one of the hard coat layer and the low refractive index layer containing the fluorine-containing polymer can be coated by the micro gravure coating method on a transparent substrate of a rolled form, unwound in a continuous manner.

Coating conditions in the micro gravure coating method include a number of lines of the gravure pattern etched in the gravure roll preferably of 50 to 800 line/inch, more preferably 100 to 300 line/inch, a depth of the gravure pattern preferably of 1 to 600 μm, more preferably 5 to 200 μm, a revolution of the gravure roll preferably of 3 to 800 rpm, more preferably 5 to 200 rpm, and a transporting speed of the substrate preferably of 0.5 to 100 m/min, more preferably 1 to 50 m/min.

An antireflection film of the invention thus obtained has a reflectance A (average reflectance of a normal spectral reflectance of 450 to 650 nm at an incident angle of 5°) OF 2.0% or less, preferably 1.5% or less.

A polarizing plate is principally constituted of a polarizer and two protective films sandwiching the same on both sides. The antireflection film of the invention is preferably employed in at least one of the two protective films sandwiching the polarizer on both sides thereof. The antireflection film of the invention, being employed also as the protective film, allows to reduce the production cost of the polarizing plate. Also the antireflection film of the invention, employed in the outermost layer, can provide a polarizing plate capable of preventing a reflection of an external light and excellent in a scratch resistance and an antistain property.

As the polarizer, there may be employed an already known polarizer, or a polarizer cut out from a web-shaped polarizer of which an absorbing axis is not parallel nor perpendicular to the longitudinal direction. A web-shaped polarizer of which an absorbing axis is not parallel nor perpendicular to the longitudinal direction can be prepared by a following method.

More specifically, it is a polarizer formed by stretching a continuously supplied polymer film by giving a tension by holding both edge portions thereof with holding means, and can be produced by a stretching method of stretching the film by 1.1 to 20.0 times in at least a transversal direction of the film, in which a difference in the longitudinal advancing speed between the holding devices on both edges of the film is 3% or less and in which the advancing direction of the film is bent in a state, where the both edges of the film are supported, in such a manner that the film advancing direction at an exit of the step of supporting both edges of the film is inclined by 20° to 70° to the substantial stretching direction of the film. An inclination angle of 45° is employed advantageously in consideration of the productivity.

A stretching method for the polymer film is described in JP-A No. 2002-86554, paragraph 0020 to 0030.

(Image Display)

An image display of the invention is characterized in that an antireflection film of the invention or a polarizing plate, having an antireflection film as a protective film, is provided on an image display plane. Thus, the antireflection film of the invention or the polarizing plate, having the antireflection film as the protective film, can be applied to an image display such as a liquid crystal display (LCD) or an organic EL display. The image display of the invention is preferably applied to a transmission or reflective liquid crystal display of TN, STN, IPS, VA or OCB mode. In the following such apparatus will be explained further.

The liquid crystal display can be any of known types, such as those described for example in Tatsuo Uchida, “Reflective color LCD Technologies”, published by CMC Co., 1999, “New Developments of Flat Panel Display”, Toray Research Center, 1996, and “Ekisho Kanren Shijo no Genjo to Shorai Tenbo (Vol. I and Vol. II)”, Fuji Kimera Soken Co., 2003.

More specifically, it can be advantageously employed in a transmissive, reflective or semi-reflective liquid crystal display of a twisted nematic mode (TN), a super twisted nematic mode (STN), a vertical alignment mode (VA), an in-plain switching mode (IPS), or an optically compensatory bend mode (OCB).

The antireflection film of the invention shows, even in case the liquid crystal display has a displayed image of a size of 17 inches or larger, a satisfactory contrast, and a wide viewing angle and is capable of preventing a change in chromaticity and a reflection of the external light.

(TN Mode Liquid Crystal Display)

A liquid crystal cell of TN mode is most frequently employed as a color TFT liquid crystal display, and is described in various literatures. In the TN mode, rod-shaped liquid crystal molecules assume, in a black display state, a standing alignment state in a central portion of the cell, and a lying alignment state in the vicinity of the substrates of the cell.

For the TN mode, an optical compensation film having an optical compensation layer containing an optically anisotropic layer is useful. There is particularly preferred an optical compensation film in which the optically anisotropic layer is formed by a compound having a discotic structural unit, of which a disc plane is inclined to the surface of the transparent substrate of the optical compensation film, and an angle between the disc plane of the discotic structural unit and the surface of the transparent substrate changes in a direction of depth of the optically anisotropic layer.

### (OCB Mode Liquid Crystal Display)

A liquid crystal cell of OCB mode adopts a bent alignment in which the rod-shaped liquid crystal molecules are aligned in substantially opposite directions (in symmetric manner) in upper and lower portions of the liquid crystal cell. In a liquid crystal display employing a liquid crystal cell of such bent alignment mode as described in U.S. Pat. Nos. 4,583,825 and 5,410,422, the liquid crystal cell of the bent alignment mode has an optical self-compensating function, because of alignments symmetrical in the upper and lower portions of the liquid crystal cell. For this reason, such liquid crystal mode is called an OCB (optically compensatory bend) mode.

In the OCB mode, as in the TN mode, rod-shaped liquid crystal molecules assume, in a black display state, a standing alignment state in a central portion of the cell, and a lying alignment state in the vicinity of the substrates of the cell.

(VA Mode Liquid Crystal Display)

In a liquid crystal cell of VA mode, rod-shaped liquid crystal molecules are aligned substantially vertically in the absence of voltage application.

The liquid crystal cell of VA mode includes (1) a liquid crystal cell of VA mode of narrow sense in which the rod-shaped liquid crystal molecules are aligned substantially vertically in the absence of a voltage application and aligned substantially horizontally under a voltage application (described in JP-A No. 2-176625), (2) a liquid crystal cell (of MVA mode) in which the VA mode is formed in multi domains for expanding the viewing angle (SID97, Digest of tech. papers (preprints) 28 (1997), 845), (3) a liquid crystal cell of an n-ASM mode in which the rod-shaped liquid crystal molecules are aligned substantially vertically in the absence of a voltage application and are aligned in twisted multi domains under a voltage application (described in Japan Liquid Crystal Seminar, preprints 58-59 (1998)), and (4) a liquid crystal cell of a SURVAIVAL mode (reported at LCD International 98).

For the VA mode, an optical compensation film having a retardation Re defined by an equation (II) within a range of 20 to 70 nm, a retardation Rth defined by an equation (III) within a range of 70 to 400 nm, and a ratio (Re/Rth) of the retardation Re and the retardation Rth within a range of 0.2 to 0.4:

Re=(nx−ny)×d (II)

Rth={(nx+ny)/2−nz}×d (III)

wherein nx is a refractive index in a slow axis direction in the film plane, ny is a refractive index in a fast axis direction in the film plane, nz is a refractive index in the film thickness direction, and d is a film thickness. The Re and Rth retardation values can be measured at a wavelength of 633 nm with for example, an ellipsometer (for example M-150, manufactured by Jasco Corp).

A slow axis of the optical compensation film and a transmission axis of the polarizer are positioned substantially parallel. More specifically, an angle between the slow axis of the optical compensation film and the transmission axis of the polarizer is preferably 5° or less, more preferably 3° or less and further preferably 10 or less.

(IPS Mode Liquid Crystal Display)

In a liquid crystal cell of IPS mode, the liquid crystal molecules are always rotated in a horizontal plane to the substrate, and are aligned with a certain angle to a longitudinal direction of electrodes in the absence of a voltage application but are shifted to a direction along an electric field, in the presence of a voltage application. An optical transmittance can be changed by positioning polarizing plates, sandwiching the liquid crystal cell, at specified angles. There are employed liquid crystal molecules of a nematic liquid crystal with a positive dielectric anisotropy Δ∈. A thickness (gap) of the liquid crystal layer is selected larger than 2.8 μm but smaller than 4.5 μm. Transmission characteristics with scarce wavelength dependence within the visible wavelength range can be obtained in case a retardation Δn·d is larger than 0.25 μm and smaller than 0.32 μm. A maximum transmittance can be obtained, by a combination of the polarizing plates, when the liquid crystal molecules are rotated by 45° from the rubbing direction toward the direction of the electric field. The thickness (gap) of the liquid crystal layer is controlled by polymer beads. A similar gap can naturally be obtained with glass beads, glass fibers, or resinous rod-shaped spacers. Also any nematic liquid crystal molecules may be employed without restriction. A dielectric anisotropy Δ∈ is preferably larger for reducing a driving voltage, and a refractive index anisotropy Δn is preferably smaller for increasing the thickness (gap) of the liquid crystal layer thereby reducing a liquid crystal pouring time and reducing a fluctuation in the gap.

(Other Liquid Crystal Modes)

The polarizing plate of the invention can be applied to a liquid crystal display of STN mode in a similar manner as explained above. Also it can be similarly applied to an apparatus of ECB mode.

Also the polarizing plate of the invention can be applied, in a combination with a λ/4 plate, in a polarizing plate of a reflective liquid crystal display or in a surface protective plate for an organic EL display, for reducing the light reflected from the surface and from the interior.

### EXAMPLES

In the following, the present invention will be further clarified by examples, but the present invention is not limited to such examples. In the following description, “part” and “%” are based on weight unless specified otherwise.

(Synthesis of Perfluoroolefin Copolymer (1))

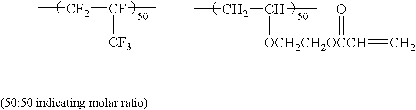

In a stainless steel autoclave of a capacity of 100 ml equipped with an agitator, 40 ml of ethyl acetate, 14.7 g of hydroxyethyl vinyl ether and 0.55 g of dilauryol peroxide were charged, and the interior of the system was evacuated and replaced with nitrogen gas. Then 25 g of hexafluoropropylene (HFP) were introduced into the autoclave, which was then heated to 65° C. The autoclave showed a pressure of 0.53 MPa (5.4 kg/cm²) when the internal temperature reached 65° C. The reaction was continued for 8 hours while maintaining this temperature, then the heating was terminated when the pressure reached 0.31 MPa (3.2 kg/cm²) and the system was let to cool by standing. When the internal temperature was lowered to the room temperature, the unreacted monomer was expelled and the reaction liquid was taken out by opening the autoclave. The obtained reaction liquid was poured into hexane of a large excess, and a precipitated polymer was obtained by decanting the solvent. The polymer was then dissolved in a small amount of ethyl acetate and re-precipitated twice from hexane to completely eliminate the residual monomer. 28 g of polymer were obtained after drying. Thereafter, 20 g of the polymer were dissolved in 100 ml of N,N-dimethylacetamide, then 11.4 g of acrylic chloride were dropwise added under cooling with ice and the mixture was agitated for 10 hours at the room temperature. The reaction liquid was added with ethyl acetate, washed with water and the organic layer was extracted and concentrated. Obtained polymer was re-precipitated from hexane to obtain 19 g a perfluoroolefin copolymer (1). The obtained polymer had a refractive index of 1.421.

(Preparation of Sol Component)

In a reactor equipped with an agitator and a reflux condenser, 120 parts of methyl ethyl ketone, 100 parts of acryloyloxypropyl trimethoxysilane (KBM-5103, manufactured by Shin-Etsu Chemical Co.) and 3 parts of diisopropoxy ethylacetacetate aluminum (trade name: Chelope EP-12, manufactured by Hope Seiyaku Co.) were charged and mixed, and 30 parts of ion-exchanged water were added. The mixture was reacted for 4 hours at 60° C., and was cooled to the room temperature to obtain a sol liquid. It showed a weight-averaged molecular weight of 1,600, and, among oligomer and larger components, components having a molecular weight within a range of 1,000 to 20,000 represented 100%. Also a gas chromatography analysis indicated that the acryloyloxypropyl trimethoxysilane employed as the raw material did not remain at all.

(Preparation of Coating Liquid A for Hard Coat Layer)

15 g of a mixture of dipentaerythritol pentaacrylate and dipentaerythritol hexaacrylate (DPHA, manufactured by Nippon Kayaku Co.) and 24 g of trimethylolpropane EO-addition triacrylate (Viscote #360, manufactured by Osaka Organic Chemical Industry Ltd.) were mixed diluted with 10 g of methyl isobutyl ketone and 6 g of methyl ethyl ketone. Also 2 g of a polymerization initiator (Irgacure 184, manufactured by Ciba Specialty Chemicals Co.) were added and mixed under agitation. A film obtained by coating and ultraviolet curing of this solution showed a refractive index of 1.53.

To this solution, there were added 23 g of a dispersion prepared by dispersing a 30% methyl isobutyl ketone dispersion obtained by dispersing classification-intensified crosslinked polystyrene particles of an average particle size of 3.5 μm (SXS-350H, manufactured by Soken Chemical & Engineering Co.) for 20 minutes at 10,000 rpm in a Polytron disperser, and the mixture was agitated to obtain a completed liquid.

The mixed liquid was filtered with a polypropylene filter of a pore size of 30 m to obtain a coating liquid A for the hard coat layer.

(Preparation of Coating Liquid B for Hard Coat Layer)

A coating liquid B for the hard coat layer was prepared in the same manner as the coating liquid A for the hard coat layer except that 1.2 g of a sol component of organosilane were added to obtain a mixture liquid, which was finally filtered with a polypropylene filter of a pore size of 30 μm to obtain a coating liquid B for the hard coat layer.

(Preparation of Coating Liquid C for Hard Coat Layer)

285 g of a commercial UV curable hard coat liquid containing zirconia (Desolite Z7404, manufactured by JSR Corp., solid content: ca. 61%, ZrO₂ content in solid: ca. 70%, containing a polymerizable monomer and a polymerization initiator) and 85 g of a mixture of dipentaerythritol pentaacrylate and dipentaerythritol hexaacrylate (DPHA, manufactured by Nippon Kayaku Co.) were mixed, and diluted with 60 g of methyl isobutyl ketone and 17 g of methyl ethyl ketone. A film obtained by coating and ultraviolet curing of this solution showed a refractive index of 1.61.

To this solution, there were added 35 g of a dispersion prepared by dispersing a 30% methyl isobutyl ketone dispersion of classification-intensified crosslinked PMMA particles of an average particle size of 3.0 μm (MXS-300, manufactured by Soken Chemical & Engineering Co.) for 20 minutes at 10,000 rpm with a Polytron disperser, and then 130 g of a dispersion prepared by dispersing a 30% methyl ethyl ketone dispersion of classification-intensified crosslinked PMMA particles of an average particle size of 1.5 μm (MXS-150H, manufactured by Soken Chemical & Engineering Co., containing ethylene glycol dimethacrylate as a crosslinking agent in an amount of 30%) for 30 minutes at 10,000 rpm with a Polytron disperser, and the mixture was agitated to obtain a completed liquid.

The mixed liquid was filtered with a polypropylene filter of a pore size of 30 μm to obtain a coating liquid C for the light scattering layer.

(Preparation of Coating Liquid D for Hard Coat Layer)

A coating liquid D for the hard coat layer was prepared in the same manner as the coating liquid C for the hard coat layer except that 28 g of a silane coupling agent (KBM-5103, manufactured by Shin-etsu Chemical Co.) were added to obtain a mixture liquid, which was finally filtered with a polypropylene filter of a pore size of 30 μm to obtain a coating liquid D for the hard coat layer.

(Preparation of Low Refractive Index Coating Liquid a)

18.5 g of a perfluoroolefin copolymer (1) were mixed with 0.4 g of reactive silicone (trade name: Silicone-X-22-164B, manufactured by Shin-etsu Chemical Co.), 0.9 g of a photopolymerization initiator (trade name: Irgacure 907, manufactured by Ciba Specialty Chemicals Co.), 305.8 g of methyl ethyl ketone and 9.4 g of cyclohexanone under agitation and filtered with a polypropylene filter with a pore size of 5 μm to obtain a coating liquid a for the low refractive index layer.

(Preparation of Low Refractive Index Coating Liquid b1)

12.4 g of a perfluoroolefin copolymer (1) were mixed with 20.3 g of silica sol (trade name: MEK-ST-L, manufactured by Nissan Chemical Co., average particle size: 45 nm, solid concentration: 30%), 0.3 g of reactive silicone (trade name: Silicone-X-22-164B, manufactured by Shin-etsu Chemical Co.), 0.6 g of a photopolymerization initiator (trade name: Irgacure 907, manufactured by Ciba Specialty Chemicals Co.), 292.0 g of methyl ethyl ketone and 9.4 g of cyclohexanone under agitation and filtered with a polypropylene filter with a pore size of 5 μm to obtain a coating liquid b1 for the low refractive index layer.

(Preparation of Low Refractive Index Coating Liquid c1a)

A coating liquid c1a for the low refractive index layer was prepared in the same manner as the coating liquid b1 for the low refractive index layer, except that the silica sol therein was changed to 30.5 g of hollow silica sol (trade name: CS-60, manufactured by Shokubai Kasei Kogyo Co., refractive index: 1.20, average particle size: 60 nm, shell thickness: 10 nm, pore rate: 58%, solid concentration: 20%) and an amount of methyl ethyl ketone was changed to 281.8 g to obtain a mixture liquid, which was finally filtered with a polypropylene filter of a pore size of 5 μm to obtain a coating liquid c1a for the low refractive index layer.

(Preparation of Low Refractive Index Coating Liquid c1b)

A coating liquid c1b for the low refractive index layer was prepared in the same manner as the coating liquid b1 for the low refractive index layer, except that the silica sol therein was changed to 30.5 g of hollow silica sol (isopropyl alcohol silica sol, average particle size: 60 nm, shell thickness: 10 nm, silica concentration: 20 weight %, refractive index of silica particles: 1.31, prepared according to Preparation Example 4 in JP-A No. 2002-79616, with a change in size) and an amount of methyl ethyl ketone was changed to 281.8 g to obtain a mixture liquid, which was finally filtered with a polypropylene filter of a pore size of 5 μm to obtain a coating liquid c1b for the low refractive index layer.

(Preparation of Low Refractive Index Coating Liquid d1)

A coating liquid d1 for the low refractive index layer was prepared in the same manner as the coating liquid b1 for the low refractive index layer, except that 0.8 g of a sol component of organosilane were added to obtain a mixture liquid, which was finally filtered with a polypropylene filter of a pore size of 5 μm to obtain a coating liquid d1 for the hard coat layer.

(Preparation of Low Refractive Index Coating Liquid e)

15 g of a thermocrosslinkable fluorine-containing polymer of a refractive index of 1.42 (trade name: JN7228A, manufactured by JSR Corp., solid concentration: 6%) were mixed with 1.4 g of silica sol (trade name: MEK-ST-L, manufactured by Nissan Chemical Co., average particle size: 45 nm, solid concentration: 30%), 0.4 g of a sol component of organosilane, 3.0 g of methyl ethyl ketone, and 0.6 g of cyclohexanone under agitation and filtered with a polypropylene filter with a pore size of 1 μm to obtain a coating liquid e for the low refractive index layer.

### Example 1

### Preparation of Antireflection Film (Embodiment 1)

### Example Sample 1-1

(1) Coating of Hard Coat Layer

A triacetyl cellulose film of a thickness of 80 μm (TAC-TD80U, manufactured by Fuji Photo Film Co., Ltd.) in a roll form was unwound as a substrate and coated with the hard coat layer coating liquid A, utilizing a microgravure roll of a diameter of 50 mm having a gravure pattern of lines of 180 line/inch and a depth of 40 μm and a doctor blade, under a gravure roll revolution of 30 rpm and a transporting speed of 10 m/min, then dried for 150 seconds at 60° C., and irradiated with an ultraviolet light of an illumination intensity of 300 mW/cm² and an illumination amount of 250 mJ/cm² utilizing an air-cooled metal halide lamp of 120 W/cm (manufactured by Eyegraphics Co.) under nitrogen purging (oxygen concentration of 0.1% by volume) to cure the coated layer, thereby obtaining a hard coat layer of a thickness of 7.0 μm, and the film was thereafter wound again.

(2) Coating of Low Refractive Index Layer

The triacetyl cellulose film coated with the hard coat layer was unwound again and coated with the prepared coating liquid a for the low refractive index layer, utilizing a microgravure roll of a diameter of 50 mm having a gravure pattern of lines of 180 line/inch and a depth of 40 μm and a doctor blade, under conditions of a gravure roll revolution of 30 rpm and a transporting speed of 15 m/min, then dried for 150 seconds at 120° C., and irradiated with an ultraviolet light of an illumination intensity of 400 mW/cm² and an illumination amount of 750 mJ/cm² utilizing an air-cooled metal halide lamp of 240 W/cm (manufactured by Eyegraphics Co.) under nitrogen purging (oxygen concentration 0.03% by volume) to obtain a low refractive index layer of a thickness of 100 nm. The film was thereafter wound again.

(3) Saponification Treatment of Antireflective Film

After the film formation, the aforementioned sample was subjected to following treatment.

A 1.5 mol/L aqueous solution of sodium hydroxide was prepared and maintained at 55° C. Also a 0.005 mol/L dilute aqueous solution of sulfuric acid was prepared and maintained at 35° C. The prepared antireflection film was immersed in the aqueous sodium hydroxide solution for 2 minutes. Then it was immersed in water to sufficiently wash off the aqueous sodium hydroxide solution. Then it was immersed in the dilute aqueous sulfuric acid solution for 1 minute, and was immersed in water to sufficiently wash off the dilute aqueous sulfuric acid solution. Finally, the sample was sufficiently dried at 120° C.

In this manner there was prepared a saponified antireflection film, which is represented as sample 1-1.

(Evaluation of Antireflection Film)

The obtained film was evaluated for following items.

(1) Average Reflectance (Reflectance A)

A normal spectral reflectance at an incident angle of 5° was measured within a wavelength range of 380 to 780 nm with a spectrophotometer (V-550, manufactured by Jasco Corp.). Based on the obtained result there was calculated an average reflectance in a wavelength range of 450 to 650 nm.

(2) Rubber Eraser Rubbing Test

On an apparatus executing a reciprocating motion at a speed of 1 m/min (surface property measuring instrument HEIDON-14, manufactured by Shinto Kagaku Co.), a rubber eraser matching “plastic eraser” defined in JIS-S-6050-1994 and shaped into a cylindrical form of a diameter of 8 mm and a height of 5 mm is mounted with a double-stick tape or the like, then a surface at the side of the low refractive index layer is rubbed in 50 reciprocating cycles under a load of 9.8 N/cm² and an average reflectance measured and calculated with the spectrophotometer in the same manner as described above is taken as the reflectance B. A change rate of reflectance in an eraser rubbing test was calculated by equation (1):

$$reflectance change rate ( \% ) = \frac{reflectance B - reflectance A}{reflectance A} \times 100$$

A sample with a reflectance change rate of 30% or less was evaluated as acceptable, and data outside this range were marked as (NG) in Tables 2 to 5.

(Preparation of Example Samples 1-2 to 1-40, Comparative Samples 1-A and 1-B, and Comparative Samples 1-1 to 1-8)

Example Samples 1-2 to 1-40, Comparative Samples 1-A and 1-B, and Comparative Samples 1-1 to 1-8 were prepared in the same manner as Example Sample 1-1 except that the coating liquids (B to D) for the hard coat layer were changed and the coating liquids (b to e) for the low refractive index layer were changed as shown in Tables 3 to 6 and were evaluated.

The low refractive index layer coating liquids b2 to b4, c2 to c4 and d2 to d4 were same as the low refractive index layer coating liquids b1, c1a and d1 except that the average particle size of silica fine particles, the pore rate of hollow silica sol (fine particles) and the sol component ratio of organosilane (a ratio of addition to the total solid for each layer) were changed as shown in following tables.

The hard coat layer made a thickness, after drying, of 7.0 μm in the coating liquid A or B and 3.4 μm in the coating liquid C or D.

TABLE 3

| | | | low refractive index layer | | | | | | | | |
|---|---|---|---|---|---|---|---|---|---|---|---|
| | | | | | | hollow | | | | | |
| | hard coat layer | | | oxygen | | silica | silica | sol | | | |
| | | sol | | concen- | silica | pore | particles | compo- | rubber eraser rubbing test | | |
| | coating | component | coating | tration | particle | rate | refractive | nent | reflectance | reflectance | change |
| | liquid | ratio (%) | liquid | (%) | size (nm) | (%) | index | ratio (%) | A (%) | B (%) | rate (%) |
| Example Sample 1-1 | A | — | a | 0.03 | — | — | — | — | 1.70 | 2.07 | 22 |
| Example Sample 1-2 | A | — | a | 0.01 | — | — | — | — | 1.71 | 2.02 | 18 |
| Example Sample 1-3 | A | — | a | 0.005 | — | — | — | — | 1.71 | 1.95 | 14 |
| Example Sample 1-4 | A | — | a | 0.001 | — | — | — | — | 1.71 | 1.85 | 8 |
| Comparative Sample 1-1 | A | — | a | 0.05 | — | — | — | — | 1.69 | 2.92 | 73 (NG) |
| Example Sample 1-5 | A | — | b1 | 0.03 | 45 | — | 1.45 | — | 1.70 | 2.04 | 20 |
| Example Sample 1-6 | A | — | b2 | 0.03 | 80 | — | 1.45 | — | 1.71 | 2.04 | 19 |
| Example Sample 1-7 | A | — | b3 | 0.03 | 100 | — | 1.45 | — | 1.69 | 2.01 | 19 |
| Example Sample 1-8 | A | — | b4 | 0.03 | 120 | — | 1.45 | — | 1.67 | 1.97 | 18 |
| Example Sample 1-9 | A | — | c1a | 0.03 | 60 (hollow) | 58 | 1.20 | — | 1.22 | 1.56 | 28 |
| Example Sample 1-10 | A | — | c2 | 0.03 | 60 (hollow) | 10 | 1.40 | — | 1.63 | 1.97 | 21 |
| Example Sample 1-11 | A | — | c3 | 0.03 | 60 (hollow) | 36 | 1.30 | — | 1.44 | 1.77 | 23 |
| Comparative Sample 1-A | A | — | c4 | 0.03 | 60 (hollow) | 65 | 1.15 | — | 1.09 | 1.73 | 59 (NG) |
| Example Sample 1-12 | A | — | d1 | 0.03 | 45 | — | 1.45 | 1.0 | 1.70 | 2.02 | 19 |
| Example Sample 1-13 | A | — | d2 | 0.03 | 45 | — | 1.45 | 5.0 | 1.70 | 2.03 | 19 |
| Example Sample 1-14 | A | — | d3 | 0.03 | 45 | — | 1.45 | 10.0 | 1.71 | 2.01 | 18 |
| Example Sample 1-15 | A | — | d4 | 0.03 | 45 | — | 1.45 | 20.0 | 1.72 | 1.99 | 16 |
| Comparative Sample 1-2 | A | — | e | (thermal | 45 | — | 1.45 | 1.0 | 1.71 | 3.15 | 84 (NG) |
| | | | | curing) | | | | | | | |

TABLE 4

| | | | low refractive index layer | | | | | | | | |
|---|---|---|---|---|---|---|---|---|---|---|---|
| | hard coat layer | | | oxygen | silica | hollow | silica | | | | |
| | | sol | | concen- | particle | silica | particles | sol | rubber eraser rubbing test | | |
| | coating | component | coating | tration | size | pore rate | refractive | component | reflectance | reflectance | change |
| | liquid | ratio (%) | liquid | (%) | (nm) | (%) | index | ratio (%) | A (%) | B (%) | rate (%) |
| Example Sample 1-16 | B | 1.0 | a | 0.03 | — | — | — | — | 1.71 | 2.03 | 19 |
| Example Sample 1-17 | B | 1.0 | d1 | 0.03 | 45 | — | 1.45 | 1.0 | 1.70 | 2.01 | 18 |
| Example Sample 1-18 | B | 1.0 | d2 | 0.03 | 45 | — | 1.45 | 5.0 | 1.71 | 2.00 | 17 |
| Example Sample 1-19 | B | 1.0 | d3 | 0.03 | 45 | — | 1.45 | 10.0 | 1.71 | 1.97 | 15 |
| Example Sample 1-20 | B | 1.0 | d4 | 0.03 | 45 | — | 1.45 | 20.0 | 1.73 | 1.96 | 13 |
| Comparative Sample 1-3 | B | 1.0 | d4 | 0.05 | 45 | — | 1.45 | 20.0 | 1.73 | 2.66 | 54 (NG) |
| Comparative Sample 1-4 | B | 1.0 | e | (thermal | 45 | — | 1.45 | 1.0 | 1.70 | 2.89 | 70 (NG) |
| | | | | curing) | | | | | | | |

TABLE 5

| | | | low refractive index layer | | | | | | | | |
|---|---|---|---|---|---|---|---|---|---|---|---|
| | | | | | | hollow | | | | | |
| | hard coat layer | | | oxygen | | silica | silica | sol | rubber eraser rubbing test | | |
| | | sol | | concen- | silica | pore | particles | compo- | | reflect- | |
| | coating | component | coating | tration | particle | rate | refractive | nent | reflectance | ance | change |
| | liquid | ratio (%) | liquid | (%) | size (nm) | (%) | index | ratio (%) | A (%) | B (%) | rate (%) |
| Example Sample 1-21 | C | — | a | 0.03 | — | — | — | — | 1.40 | 1.74 | 24 |
| Example Sample 1-22 | C | — | a | 0.01 | — | — | — | — | 1.39 | 1.67 | 20 |
| Example Sample 1-23 | C | — | a | 0.005 | — | — | — | — | 1.40 | 1.62 | 16 |
| Example Sample 1-24 | C | — | a | 0.001 | — | — | — | — | 1.40 | 1.53 | 9 |
| Comparative Sample 1-5 | C | — | a | 0.05 | — | — | — | — | 1.41 | 2.53 | 79 (NG) |
| Example Sample 1-25 | C | — | b1 | 0.03 | 45 | — | 1.45 | — | 1.40 | 1.71 | 22 |
| Example Sample 1-26 | C | — | b2 | 0.03 | 80 | — | 1.45 | — | 1.41 | 1.73 | 23 |
| Example Sample 1-27 | C | — | b3 | 0.03 | 100 | — | 1.45 | — | 1.41 | 1.71 | 21 |
| Example Sample 1-28 | C | — | b4 | 0.03 | 120 | — | 1.45 | — | 1.38 | 1.66 | 20 |
| Example Sample 1-29 | C | — | c1a | 0.03 | 60 (hollow) | 58 | 1.20 | — | 1.02 | 1.32 | 29 |
| Example Sample 1-30 | C | — | c2 | 0.03 | 60 (hollow) | 10 | 1.40 | — | 1.30 | 1.61 | 24 |
| Example Sample 1-31 | C | — | c3 | 0.03 | 60 (hollow) | 36 | 1.30 | — | 1.16 | 1.46 | 26 |
| Comparative Sample 1-B | C | — | c4 | 0.03 | 60 (hollow) | 65 | 1.15 | — | 0.95 | 1.42 | 50 (NG) |
| Example Sample 1-32 | C | — | d1 | 0.03 | 45 | — | 1.45 | 1.0 | 1.40 | 1.71 | 22 |
| Example Sample 1-33 | C | — | d2 | 0.03 | 45 | — | 1.45 | 5.0 | 1.41 | 1.71 | 21 |
| Example Sample 1-34 | C | — | d3 | 0.03 | 45 | — | 1.45 | 10.0 | 1.42 | 1.69 | 19 |
| Example Sample 1-35 | C | — | d4 | 0.03 | 45 | — | 1.45 | 20.0 | 1.44 | 1.69 | 17 |
| Comparative Sample 1-6 | C | — | e | (thermal | 45 | — | 1.45 | 1.0 | 1.40 | 3.11 | 122 (NG) |
| | | | | curing) | | | | | | | |

TABLE 6

| | | | low refractive index layer | | | | | | | | |
|---|---|---|---|---|---|---|---|---|---|---|---|
| | hard coat layer | | | oxygen | silica | hollow | silica | | | | |
| | | sol | | concen- | particle | silica | particles | sol | rubber eraser rubbing test | | |
| | coating | component | coating | tration | size | pore rate | refractive | component | reflectance | reflectance | change |
| | liquid | ratio (%) | liquid | (%) | (nm) | (%) | index | ratio (%) | A (%) | B (%) | rate (%) |
| Example Sample 1-36 | D | 8.3 | a | 0.03 | — | — | — | — | 1.42 | 1.72 | 21 |
| Example Sample 1-37 | D | 8.3 | d1 | 0.03 | 45 | — | 1.45 | 1.0 | 1.43 | 1.69 | 18 |
| Example Sample 1-38 | D | 8.3 | d2 | 0.03 | 45 | — | 1.45 | 5.0 | 1.44 | 1.67 | 16 |
| Example Sample 1-39 | D | 8.3 | d3 | 0.03 | 45 | — | 1.45 | 10.0 | 1.45 | 1.64 | 13 |
| Example Sample 1-40 | D | 8.3 | d4 | 0.03 | 45 | — | 1.45 | 20.0 | 1.46 | 1.64 | 12 |
| Comparative Sample 1-7 | D | 8.3 | d4 | 0.05 | 45 | — | 1.45 | 20.0 | 1.46 | 2.28 | 56 (NG) |
| Comparative Sample 1-8 | D | 8.3 | e | (thermal | 45 | — | 1.45 | 1.0 | 1.42 | 2.53 | 78 (NG) |
| | | | | curing) | | | | | | | |

In Tables 3 to 6, “thermal curing” means a sample subjected to a thermal curing under the air without control of the oxygen concentration.

Also the sol component ratio indicates a proportion (%) of the amount of addition to the total solid in each layer.

Results shown in Tables 3 to 6 indicate followings.

The antireflection film of the invention provided with the low refractive index layer obtained by curing (crosslinking) a fluorine-containing polymer of the invention (copolymer which contains a polymerization unit derived from a fluorine-containing vinyl monomer and a polymerization unit having a (meth)acryloyl group in a side chain thereof, the copolymer having a main chain of only carbon atoms, in an atmosphere with an oxygen concentration of 0.03% by volume or less, showed an excellent scratch resistance and an excellent antireflection property.

Inclusion of silica fine particles as the inorganic fine particles in the low refractive index layer could further improve the scratch resistance. However silica fine particles of a size larger than the thickness of the low refractive index layer (Example Samples 1-8 and 1-28) were acceptable in the scratch resistance and the antireflection property but deteriorated the coated surface property and were unacceptable for the practical use.

Replacement of the silica fine particles with the hollow silica fine particles can significantly reduce the reflectance, because of a reduction of the refractive index of the silica particles themselves, thereby providing an excellent antireflection film. However, an increase in the pore rate decreases the contribution to the improvement in the scratch resistance because the strength of the silica fine particles is reduced. In case of hollow silica fine particles with a pore rate exceeding 65% (Comparative Samples 1-A and 1-B), the silica fine particles themselves are destructed in the scratch resistance test, thereby deteriorating the scratch resistance of the antireflection film.

Also an inclusion of an organosilane compound and/or a hydrolysate thereof and/or a partial condensate thereof in the coating liquid for forming the hard coat layer and/or the low refractive index layer further improved the scratch resistance, though the reflectance was somewhat increased.

Also the level of the scratch resistance in the rubber eraser rubbing test, represented by the change rate of the reflectance, facilitated comparison of samples, thereby enabling comparison of each effect of the inorganic fine particles, the sol component of organosilane, the perfluoroolefin copolymer and the hollow silica fine particles.

### Example 2

### Preparation of Antireflection Film (Embodiment 2)

### Example Sample 2-1

(1) Coating of Hard Coat Layer

A triacetyl cellulose film of a thickness of 80 μm (TAC-TD80U, manufactured by Fuji Photo Film Co., Ltd.) in a roll form was unwound as a substrate and coated with the hard coat layer coating liquid A, utilizing a microgravure roll of a diameter of 50 mm having a gravure pattern of lines of 180 line/inch and a depth of 40 μm and a doctor blade, under a gravure roll revolution of 30 rpm and a transporting speed of 10 m/min, then dried for 150 seconds at 60° C., and irradiated with an ultraviolet light of an illumination intensity of 300 mW/cm² and an illumination amount of 250 mJ/cm² utilizing an air-cooled metal halide lamp of 120 W/cm (manufactured by Eyegraphics Co.) under nitrogen purging (oxygen concentration of 0.1% by volume) to cure the coated layer, thereby obtaining a hard coat layer of a thickness of 7.0 μm, and the film was thereafter wound again.

(2) Coating of Low Refractive Index Layer

The triacetyl cellulose film coated with the hard coat layer was unwound again and coated with the prepared coating liquid a for the low refractive index layer, utilizing a microgravure roll of a diameter of 50 mm having a gravure pattern of lines of 180 line/inch and a depth of 40 μm and a doctor blade, under conditions of a gravure roll revolution of 30 rpm and a transporting speed of 15 m/min, then dried for 150 seconds at 120° C., and irradiated with an ultraviolet light of an illumination intensity of 400 mW/cm² and an illumination amount of 250 mJ/cm² utilizing an air-cooled metal halide lamp of 240 W/cm (manufactured by Eyegraphics Co.) under nitrogen purging (oxygen concentration 0.03% by volume) to obtain a low refractive index layer of a thickness of 100 nm. The film was thereafter wound again.

The temperature of the film surface was regulated by changing a temperature of a metal plate maintained in contact with the rear surface of the film.

(3) Saponification Treatment of Antireflective Film

After the film formation, the aforementioned sample was subjected to following treatment.

A 1.5 mol/L aqueous solution of sodium hydroxide was prepared and maintained at 55° C. Also a 0.005 mol/L dilute aqueous solution of sulfuric acid was prepared and maintained at 35° C. The prepared antireflection film was immersed in the aqueous sodium hydroxide solution for 2 minutes. Then it was immersed in water to sufficiently wash off the aqueous sodium hydroxide solution. Then it was immersed in the dilute aqueous sulfuric acid solution for 1 minute, and was immersed in water to sufficiently wash off the dilute aqueous sulfuric acid solution. Finally, the sample was sufficiently dried at 120° C.

In this manner there was prepared a saponified antireflection film, which is represented as sample 2-1.

(Evaluation of Antireflection Film)

The obtained film was evaluated for following items.

(1) Average Reflectance

A normal spectral reflectance at an incident angle of 5° was measured within a wavelength range of 380 to 780 nm with a spectrophotometer (V-550, manufactured by Jasco Corp.). Based on the obtained result there was calculated an average reflectance in a wavelength range of 450 to 650 nm.

(2) Non-Woven Cloth Rubbing Test

A normal spectral reflectance at an incident angle of 40° was measured within a wavelength range of 380 to 780 nm with a spectrophotometer (V-550, manufactured by Jasco Corp.). Then, based on the obtained data and the spectral data under the CIE D₆₅ standard light source, the L*, a* and b* values in the CIE1976 L*a*b* color space under the CIE D₆₅ standard light source are calculated as explained before to provide L₁*, a₁*, and b₁* values.

On a friction element of an apparatus executing a reciprocating motion at a speed of 6 m/in (Gakushin type friction resistance tester AB-301, manufactured by Tester Sangyo Co.), a non-woven cloth Bemcot M-3 (manufactured by Asahi Kasei Corp.) was mounted while an antireflection film is mounted on a test piece table, then a surface at the side of the low refractive index layer was rubbed in 200 reciprocating cycles under a load of 19.6 N/cm² and L*, a*, and b* values measured and calculated with the spectrophotometer in the same manner as described above were taken as the L₂*, a₂* and b₂* values.

A chromaticity difference ΔEab* in the non-woven-cloth rubbing test was calculated by equation (II):

ΔEab*=((ΔL*)²+(Δa*)²+(Δb*)²)^{1/2}

ΔL*=L₁*−L₂*

Δa*=a₁*−a₂*

Δb*=b₁*−b₂*

A sample with a chromaticity difference ΔEab* of 1 or less was evaluated as acceptable, and data outside this range were marked as (NG) in Tables 7 to 10.

(0169)

(Preparation of Example Samples 2-2 to 2-52, Comparative Samples 2-A and 2-B, and Comparative Samples 2-1 to 2-12)

Example Samples 2-2 to 2-52, Comparative Samples 2-A and 2-B, and Comparative Samples 2-1 to 2-12 were prepared in the same manner as Example Sample 1-1 except that the coating liquids (B to D) for the hard coat layer were changed and the coating liquids (b1 to b4, c1b to c4, d1 to d4, e) for the low refractive index layer were changed as shown in Tables 7 to 10 and were evaluated.

The low refractive index layer coating liquids b2 to b4, c2 to c4 and d2 to d4 were same as the low refractive index layer coating liquids b1, c1b and d1 except that the average particle size of silica fine particles, the pore rate of hollow silica sol (fine particles) and the sol component ratio of organosilane (a ratio of addition to the total solid for each layer) were changed as shown in following tables.

The hard coat layer made a thickness, after drying, of 7.0 μm in the coating liquid A or B and 3.4 μm in the coating liquid C or D.

TABLE 7

| | | | low refractive index layer | | | | | | | | |
|---|---|---|---|---|---|---|---|---|---|---|---|
| | | | | | | | hollow | | | | |
| | hard coat layer | | | oxygen | heat- | | silica | silica | | evaluation | |
| | | sol | | concen- | ing | silica | pore | particles | sol | reflect- | |
| | coating | component | coating | tration | temp. | particle | rate | refractive | component | ance | |
| | liquid | ratio (%) | liquid | (%) | (° C.) | size (nm) | (%) | index | ratio (%) | B (%) | ΔEab* |
| Example Sample 2-1 | A | — | a | 0.03 | 60 | — | — | 1.45 | — | 1.72 | 0.89 |
| Example Sample 2-2 | A | — | a | 0.01 | 60 | — | — | 1.45 | — | 1.71 | 0.76 |
| Example Sample 2-3 | A | — | a | 0.005 | 60 | — | — | 1.45 | — | 1.70 | 0.62 |
| Example Sample 2-4 | A | — | a | 0.001 | 60 | — | — | 1.45 | — | 1.71 | 0.45 |
| Comparative Sample 2-1 | A | — | a | 0.05 | 60 | — | — | 1.45 | — | 1.71 | 1.83 (NG) |
| Example Sample 2-5 | A | — | a | 0.03 | 70 | — | — | 1.45 | — | 1.69 | 0.82 |
| Example Sample 2-6 | A | — | a | 0.03 | 80 | — | — | 1.45 | — | 1.69 | 0.74 |
| Example Sample 2-7 | A | — | a | 0.03 | 90 | — | — | 1.45 | — | 1.70 | 0.72 |
| Comparative Sample 2-2 | A | — | a | 0.03 | 50 | — | — | 1.45 | — | 1.71 | 1.11 (NG) |
| Example Sample 2-8 | A | — | b1 | 0.03 | 60 | 45 | — | 1.45 | — | 1.70 | 0.69 |
| Example Sample 2-9 | A | — | b2 | 0.03 | 60 | 80 | — | 1.45 | — | 1.70 | 0.67 |
| Example Sample 2-10 | A | — | b3 | 0.03 | 60 | 100 | — | 1.45 | — | 1.68 | 0.64 |
| Example Sample 2-11 | A | — | b4 | 0.03 | 60 | 120 | — | 1.45 | — | 1.66 | 0.59 |
| Example Sample 2-12 | A | — | c1b | 0.03 | 60 | 60 (hollow) | 58 | 1.20 | — | 1.21 | 0.85 |
| Example Sample 2-13 | A | — | c2 | 0.03 | 60 | 60 (hollow) | 10 | 1.40 | — | 1.61 | 0.78 |
| Example Sample 2-14 | A | — | c3 | 0.03 | 60 | 60 (hollow) | 36 | 1.30 | — | 1.43 | 0.82 |
| Comparative Sample 2-A | A | — | c4 | 0.03 | 60 | 60 (hollow) | 65 | 1.15 | — | 1.07 | 1.42 (NG) |
| Example Sample 2-15 | A | — | d1 | 0.03 | 60 | 45 | — | 1.45 | 1.0 | 1.69 | 0.68 |
| Example Sample 2-16 | A | — | d2 | 0.03 | 60 | 45 | — | 1.45 | 5.0 | 1.70 | 0.62 |
| Example Sample 2-17 | A | — | d3 | 0.03 | 60 | 45 | — | 1.45 | 10.0 | 1.69 | 0.59 |
| Example Sample 2-18 | A | — | d4 | 0.03 | 60 | 45 | — | 1.45 | 20.0 | 1.71 | 0.57 |
| Comparative Sample 2-3 | A | — | e | (thermal | 120 | 45 | — | 1.45 | 1.0 | 1.70 | 2.14 (NG) |
| | | | | curing) | | | | | | | |

TABLE 8

| | | | low refractive index layer | | | | | | | | |
|---|---|---|---|---|---|---|---|---|---|---|---|
| | | | | | | | hollow | | | | |
| | hard coat layer | | | | | silica | silica | silica | sol | evaluation | |
| | | sol | | oxygen | heating | particle | pore | particles | compo- | reflect- | |
| | coating | component | coating | concentration | temp. | size | rate | refractive | nent | ance | |
| | liquid | ratio (%) | liquid | (%) | (° C.) | (nm) | (%) | index | ratio (%) | B (%) | ΔEab* |
| Example Sample 2-19 | B | 1.0 | a | 0.03 | 60 | — | — | 1.45 | — | 1.71 | 0.82 |
| Example Sample 2-20 | B | 1.0 | a | 0.03 | 70 | — | — | 1.45 | — | 1.72 | 0.72 |
| Example Sample 2-21 | B | 1.0 | a | 0.03 | 80 | — | — | 1.45 | — | 1.70 | 0.64 |
| Example Sample 2-22 | B | 1.0 | a | 0.03 | 90 | — | — | 1.45 | — | 1.70 | 0.62 |
| Comparative Sample 2-4 | B | 1.0 | a | 0.03 | 50 | — | — | 1.45 | — | 1.72 | 1.06 (NG) |
| Example Sample 2-23 | B | 1.0 | d1 | 0.03 | 60 | 45 | — | 1.45 | 1.0 | 1.71 | 0.67 |
| Example Sample 2-24 | B | 1.0 | d2 | 0.03 | 60 | 45 | — | 1.45 | 5.0 | 1.70 | 0.60 |
| Example Sample 2-25 | B | 1.0 | d3 | 0.03 | 60 | 45 | — | 1.45 | 10.0 | 1.71 | 0.57 |
| Example Sample 2-26 | B | 1.0 | d4 | 0.03 | 60 | 45 | — | 1.45 | 20.0 | 1.72 | 0.54 |
| Comparative Sample 2-5 | B | 1.0 | d4 | 0.05 | 60 | 45 | — | 1.45 | 20.0 | 1.72 | 1.26 (NG) |
| Comparative Sample 2-6 | B | 1.0 | e | (thermal | 120 | 45 | — | 1.45 | 1.0 | 1.70 | 1.73 (NG) |
| | | | | curing) | | | | | | | |

TABLE 9

| | | | low refractive index layer | | | | | | | | |
|---|---|---|---|---|---|---|---|---|---|---|---|
| | hard coat layer | | | | | | hollow | | | | |
| | | sol | | oxygen | | | silica | silica | | | |
| | | compo- | | concen- | heating | silica | pore | particles | sol | evaluation | |
| | coating | nent | coating | tration | temp. | particle | rate | refractive | component | reflectance | |
| | liquid | ratio (%) | liquid | (%) | (° C.) | size (nm) | (%) | index | ratio (%) | B (%) | ΔEab* |
| Example Sample 2-27 | C | — | a | 0.03 | 60 | — | — | 1.45 | — | 1.39 | 0.85 |
| Example Sample 2-28 | C | — | a | 0.01 | 60 | — | — | 1.45 | — | 1.40 | 0.69 |
| Example Sample 2-29 | C | — | a | 0.005 | 60 | — | — | 1.45 | — | 1.40 | 0.57 |
| Example Sample 2-30 | C | — | a | 0.001 | 60 | — | — | 1.45 | — | 1.39 | 0.43 |
| Comparative Sample 2-7 | C | — | a | 0.05 | 60 | — | — | 1.45 | — | 1.40 | 1.61 (NG) |
| Example Sample 2-31 | C | — | a | 0.03 | 70 | — | — | 1.45 | — | 1.39 | 0.68 |
| Example Sample 2-32 | C | — | a | 0.03 | 80 | — | — | 1.45 | — | 1.39 | 0.53 |
| Example Sample 2-33 | C | — | a | 0.03 | 90 | — | — | 1.45 | — | 1.39 | 0.52 |
| Comparative Sample 2-8 | C | — | a | 0.03 | 50 | — | — | 1.45 | — | 1.41 | 1.08 (NG) |
| Example Sample 2-34 | C | — | b1 | 0.03 | 60 | 45 | — | 1.45 | — | 1.40 | 0.67 |
| Example Sample 2-35 | C | — | b2 | 0.03 | 60 | 80 | — | 1.45 | — | 1.40 | 0.65 |
| Example Sample 2-36 | C | — | b3 | 0.03 | 60 | 100 | — | 1.45 | — | 1.39 | 0.61 |
| Example Sample 2-37 | C | — | b4 | 0.03 | 60 | 120 | — | 1.45 | — | 1.39 | 0.57 |
| Example Sample 2-38 | C | — | c1b | 0.03 | 60 | 60 (hollow) | 58 | 1.20 | — | 1.01 | 0.82 |
| Example Sample 2-39 | C | — | c2 | 0.03 | 60 | 60 (hollow) | 10 | 1.40 | — | 1.28 | 0.76 |
| Example Sample 2-40 | C | — | c3 | 0.03 | 60 | 60 (hollow) | 36 | 1.30 | — | 1.15 | 0.81 |
| Comparative Sample 2-B | C | — | c4 | 0.03 | 60 | 60 (hollow) | 65 | 1.15 | — | 0.93 | 1.34 (NG) |
| Example Sample 2-41 | C | — | d1 | 0.03 | 60 | 45 | — | 1.45 | 1.0 | 1.39 | 0.63 |
| Example Sample 2-42 | C | — | d2 | 0.03 | 60 | 45 | — | 1.45 | 5.0 | 1.41 | 0.59 |
| Example Sample 2-43 | C | — | d3 | 0.03 | 60 | 45 | — | 1.45 | 10.0 | 1.41 | 0.55 |
| Example Sample 2-44 | C | — | d4 | 0.03 | 60 | 45 | — | 1.45 | 20.0 | 1.43 | 0.52 |
| Comparative Sample 2-9 | C | — | e | (thermal | 120 | 45 | — | 1.45 | 1.0 | 1.41 | 1.63 (NG) |
| | | | | curing) | | | | | | | |

TABLE 10

| | | | low refractive index layer | | | | | | | | |
|---|---|---|---|---|---|---|---|---|---|---|---|
| | hard coat layer | | | oxygen | | silica | | silica | | | |
| | | sol | | concen- | heating | particle | hollow silica | particles | sol | evaluation | |
| | coating | component | coating | tration | temp. | size | pore rate | refractive | component | reflectance | |
| | liquid | ratio (%) | liquid | (%) | (° C.) | (nm) | (%) | index | ratio (%) | B (%) | ΔEab* |
| Example Sample 2-45 | D | 8.3 | a | 0.03 | 60 | — | — | 1.45 | — | 1.42 | 0.77 |
| Example Sample 2-46 | D | 8.3 | a | 0.03 | 70 | — | — | 1.45 | — | 1.41 | 0.55 |
| Example Sample 2-47 | D | 8.3 | a | 0.03 | 80 | — | — | 1.45 | — | 1.41 | 0.43 |
| Example Sample 2-48 | D | 8.3 | a | 0.03 | 90 | — | — | 1.45 | — | 1.40 | 0.41 |
| Comparative Sample | D | 8.3 | a | 0.03 | 50 | — | — | 1.45 | — | 1.43 | 1.04 (NG) |
| 2-10 | | | | | | | | | | | |
| Example Sample 2-49 | D | 8.3 | d1 | 0.03 | 60 | 45 | — | 1.45 | 1.0 | 1.43 | 0.62 |
| Example Sample 2-50 | D | 8.3 | d2 | 0.03 | 60 | 45 | — | 1.45 | 5.0 | 1.43 | 0.57 |
| Example Sample 2-51 | D | 8.3 | d3 | 0.03 | 60 | 45 | — | 1.45 | 10.0 | 1.44 | 0.54 |
| Example Sample 2-52 | D | 8.3 | d4 | 0.03 | 60 | 45 | — | 1.45 | 20.0 | 1.45 | 0.52 |
| Comparative Sample | D | 8.3 | d4 | 0.05 | 60 | 45 | — | 1.45 | 20.0 | 1.46 | 1.17 (NG) |
| 2-11 | | | | | | | | | | | |
| Comparative Sample | D | 8.3 | e | (thermal | 120 | 45 | — | 1.45 | 1.0 | 1.41 | 1.47 (NG) |
| 2-12 | | | | curing) | | | | | | | |

In Tables 7 to 10, “thermal curing” means a sample subjected to a thermal curing under the air without control of the oxygen concentration.

Also the sol component ratio indicates a proportion (%) of the amount of addition to the total solid in each layer.

Results shown in Tables 7 to 10 indicate followings.

The antireflection film of the invention provided with the low refractive index layer obtained by curing (crosslinking) a fluorine-containing polymer of the invention (copolymer which contains a polymerization unit derived from a fluorine-containing vinyl monomer and a polymerization unit having a (meth)acryloyl group in a side chain thereof, the copolymer having a main chain of only carbon atoms, in an atmosphere with an oxygen concentration of 0.03% by volume or less, showed an excellent scratch resistance and an excellent antireflection property.

In case the heating temperature at the curing reaction was 60° C. or higher, the antireflection film showed a superior scratch resistance as the heating temperature became higher as 70, 80 and 90° C. However, the difference in the scratch resistance was small between 80 and 90° C. Also a heating temperature of 50° C. could not provide the antireflection film with a sufficient scratch resistance.

Inclusion of silica fine particles as the inorganic fine particles in the low refractive index layer could further improve the scratch resistance. However silica fine particles of a size larger than the thickness of the low refractive index layer (Example Samples 2-11 and 2-37) were acceptable in the scratch resistance and the antireflection property but deteriorated the coated surface property and were unacceptable for the practical use.

Replacement of the silica fine particles with the hollow silica fine particles can significantly reduce the reflectance, because of a reduction of the refractive index of the silica particles themselves, thereby providing an excellent antireflection film. However, an increase in the pore rate decreases the contribution to the improvement in the scratch resistance because the strength of the silica fine particles is reduced. In case of hollow silica fine particles with a pore rate exceeding 65% (Comparative Samples 2-A and 2-B), the silica fine particles themselves are destructed in the scratch resistance test, thereby deteriorating the scratch resistance of the antireflection film.

Also an inclusion of an organosilane compound and/or a hydrolysate thereof and/or a partial condensate thereof in the coating liquid for forming the hard coat layer and/or the low refractive index layer further improved the scratch resistance, though the reflectance was somewhat increased.

Also the level of the scratch resistance in the non-woven cloth rubbing test, represented by the change rate of the reflectance, facilitated comparison of samples, thereby enabling comparison of each effect of the inorganic fine particles, the sol component of organosilane, the perfluoroolefin copolymer and the hollow silica fine particles.

### Example 3

A PVA film was immersed in an aqueous solution containing iodine at 2.0 g/l and potassium iodide at 4.0 g/l for 240 seconds at 25° C., then in an aqueous solution containing boric acid at 10 g/l for 60 seconds at 25° C., then introduced into a tenter machine of a form described in JP-A No. 2002-86554, FIG. 2, and extended by 5.3 times, whereupon the tenter was bent with respect to the extending direction as shown in FIG. 2 of the aforementioned patent literature, and the width was thereafter maintained constant. The film was detached from the tenter after drying in an atmosphere of 80° C. Tenter clips at left and right had a difference in transporting speed less than 0.05%, and a center line of the introduced film and a center line of the film advanced to a next step formed an angle of 46°. There were maintained conditions of |L1−L2| of 0.7 m and W of 0.7 m, so that |L1−L2|=W. A substantial extending direction Ax-Cx at the exit of the tenter was inclined by 45° with respect to the center line 22 of the film advanced to the next step. At the exit of the tenter, wrinkles or a film deformations were not observed.

It was then adhered to a Fujitac film (cellulose triacetate, retardation: 3.0 nm, manufactured by Fuji Photo Film Co.) subjected to a saponification, utilizing a 3% aqueous solution of PVA (PVA-117H, manufactured by Kuraray Co.) as an adhesive, and dried at 80° C. to obtain a polarizing plate of an effective width of 650 mm. The obtained polarizing plate had an absorbing axis inclined by 45° to the longitudinal direction. The polarizing plate had, at 550 nm, a transmittance of 43.7% and a polarization degree of 99.97%. It was cut into a size of 310×233 m weight known in FIG. 2, thereby providing a polarizing plate having an absorbing axis inclined by 45° to the sides, with an area yield of 91.5%.

Then the antireflection film of Example Sample 1-1 or 2-1 was adhered with the polarizing plate respectively to obtain an antiglare and antireflection polarizing plate. A liquid crystal display, prepared utilizing the polarizing plate with the antireflection layer at the outermost layer, showed an excellent contrast because of absence of reflection of the external light and an excellent visibility as a reflected light was not conspicuous due to the antiglare property.

### Example 4

A polarizing plate was prepared by adhering triacetyl cellulose film of a thickness of 80 μm (TAC-TD-80U, manufactured by Fuji Photo Film Co.), immersed in a 1.5 mol/L NaOH aqueous solution for 2 minutes at 55° C., then neutralized and rinsed with water, and a saponified triacetyl cellulose film of Example Sample 1-1 or 2-1 on both sides of a polarizer prepared by iodine adsorption and extending of polyvinyl alcohol. The polarizing plate thus prepared was used, in such a manner that the antireflection film constitutes the outermost surface, in place for a polarizing plate at the observing side, in a notebook personal computer, of a transmission TN liquid crystal display (having a polarized light separating film D-BEF having a polarized light selecting layer, manufactured by Sumitomo-3M Co., between a backlight and a liquid crystal cell), whereby a display of a very high display quality was obtained with very little reflection of the external scene.

### Example 5

On a transmission TN liquid crystal cell on which the film of Example Sample 1-1 or 2-1 was adhered respectively, a viewing angle widening film (Wide View Film SA 12B, manufactured by Fuji Photo Film Co.) was used as a protective film, at the side of the liquid crystal cell, for a polarizing plate at the observing side and as a protective film, at the side of the liquid crystal cell, of the polarizing plate at the backlight side. As a result, there was obtained a liquid crystal display showing a high contrast in a lighted room, a very wide viewing angle in upper, lower and lateral directions, an extremely excellent visibility and a high display quality.

### Example 6

A film of Example Sample 1-1 or 2-1 was adhered respectively with an adhesive on a surface glass plate of an organic EL display. As a result, the reflection on the glass surface was suppressed and a display of a high visibility could be obtained.

### Example 7

A polarizing plate having an antireflection film on a side was prepared with Example Sample 1-1 or 2-1 respectively, and, with a λ/4 plate adhered on a side opposite to the antireflection film, was adhered on a surface glass plate of an organic EL display in such a manner that the antireflection film of the invention was at the outermost surface. As a result, there was obtained a display of an extremely high visibility, by reductions of a surface reflection and a reflection from the interior of a surfacial glass.

It will be apparent to those skilled in the art that various modifications and variations can be made to the described preferred embodiments of the invention without departing from the spirit or scope of the invention. Thus, it is intended that the present invention cover all modifications and variations of this invention consistent with the scope of the appended claims and their equivalents.

This application is based on Japanese Patent Application Nos. JP2004-211763 and JP2004-256647, filed on Jul. 20, 2004 and Sep. 3, 2004, respectively, the contents of which is incorporated herein by reference.

### INDUSTRIAL APPLICABILITY

An polarizing plate according to the invention can be used as liquid crystal display with a sufficient antireflection property in addition to the scratch resistance.

1. An antireflection film comprising: a transparent substrate; a hard coat layer; and a low refractive index layer having a refractive index lower than that of the transparent substrate in this order, wherein the antireflection film has a change rate in reflectance of 30% or less, the change rate being calculated by equation (I):
$$reflectance change rate ( \% ) = \frac{reflectance B - reflectance A}{reflectance A} \times 100$$
wherein the reflectance A indicates a reflectance of the antireflection film before rubbing a surface of a side of the low refractive index layer with an eraser, and the reflectance B is a reflectance of the antireflection film after rubbing the surface of the side of the low refractive index layer with an eraser by 50 reciprocating cycles under a load of 9.8 N/cm².

2. An antireflection film comprising: a transparent substrate; a hard coat layer; and a low refractive index layer having a refractive index lower than that of the transparent substrate in this order, wherein the antireflection film has a chromaticity difference ΔEab* in a CIE1976 L*a*b* color space of 1 or less, the chromaticity difference ΔEab* being calculated by equation (II):
ΔEab*=((ΔL*)²+(Δa*)²+(Δb*)²)^{1/2}
ΔL*=L₁*−L₂*
Δa*=a₁*−a₂*
Δb*=b₁*−b₂*
wherein L₁*, a₁*, b₁* and L₂*, a₂*, b₂* are chromaticity values of a normal reflected light of the antireflection film to an incident light with an incident angle 40° under a CIE standard light source D₆₅, represented by L*, a* and b* values in the L*a*b* color space, in which L₁*, a₁* and b₁* are L*, a* and b* values of the antireflection film, respectively, before a surface at the side of the low refractive index layer is rubbed with a non-woven cloth, and L₂*, a₂* and b₂* are L*, a* and b* values of the antireflection film, respectively, after the surface at the side of the low refractive index layer is rubbed with a non-woven cloth by 200 reciprocating cycles under a load of 19.6 N/cm².

3. The antireflection film according to claim 1, wherein
the low refractive index layer is formed from a coating liquid comprising a fluorine-containing polymer that is a copolymer comprising: a polymerization unit derived from a fluorine-containing vinyl monomer; and a polymerization unit having a singly crosslinkable (meth)acryloyl group in a side chain thereof, the copolymer having a main chain of only carbon atoms, and
the low refractive index layer is crosslinked in an atmosphere with an oxygen concentration of 0.03% by volume or less.

4. The antireflection film according to claim 3, wherein the copolymer is a copolymer represented by formula (I):
wherein L represents a divalent connecting group having 1 to 10 carbon atoms; m represents 0 or 1; X represents a hydrogen atom or a methyl group; A represents a polymerization unit derived from a vinyl monomer, which is a single component or plural components; and x, y, z each represents a molar percentage of each constituent and satisfies conditions 30≦x≦60, 5≦y≦70 and 0≦z≦65.

5. The antireflection film according to claim 3, wherein the coating liquid further comprises inorganic fine particles.

6. The antireflection film according to claim 5, wherein the inorganic fine particles are hollow silica fine particles having a refractive index of 1.17 to 1.40.

7. The antireflection film according to claim 1, wherein at least one of the hard coat layer and the low refractive index layer is formed from a coating liquid comprising at least one of an organosilane compound, a hydrolysate thereof and a partial condensate thereof.

8. The antireflection film according to claim 1, wherein the low refractive index layer is a layer crosslinked by irradiating with an ionizing radiation in the presence of a photopolymerization initiator and under a heating with a film surface temperature of 60° C. or higher in an atmosphere with an oxygen concentration of 0.03% or less.

9. A polarizing plate comprising: a polarizer; and two protective films, at least one of the two protective films comprising an antireflection film according to claim 1.

10. An image display comprising an antireflection film according to claim 1.
